(19) United States
(12) Patent Application Publication
(10) Pub. No.: US 2026/0301986 A1
(43) Pub. Date: Oct. 1, 2026

(54) APPARATUS, SYSTEM AND METHOD FOR RADIOISOTOPE PRODUCTION USING ELECTRONS

(71) Applicant: Full-Life Technology Europe, Isnes (BE)

(72) Inventors: William T. DIAMOND, Deep River (CA); Carl K. ROSS, Victoria (CA)

(21) Appl. No.: 19/476,976

(22) PCT Filed: Apr. 23, 2025
(86) PCT No.: PCT/EP2024/061086

§ 371 Date: Oct. 20, 2025

(30) Foreign Application Priority Data
Apr. 24, 2023 (WO) PCT/EP2023/060665

(51) Int. Cl. G21G 1/12

(52) U.S. Cl. CPC G21G 1/12

(57) ABSTRACT

A radioisotope production apparatus including a converter assembly and a target assembly is disclosed herein. The converter assembly includes a high Z material configured to receive an electron beam to generate a photon beam by bremsstrahlung radiation and the target assembly includes a target material configured to receive the photon beam from the converter assembly to produce the one or more radioisotopes. In some cases, a beam window may be included for isolating the beam line from downstream elements including the converter and target assemblies. In some cases, a beam dump may be included to attenuate excess particles that do not contribute to generation of the one or more radioisotopes during usage of the apparatus. In another some cases, a beam shaping assembly may be included upstream of the converter assembly for adjusting an angular divergence or direction of the electron beam.

### CROSS-REFERENCE TO RELATED APPLICATIONS

The present applications priority to and the benefit of International Patent Application No. PCT/EP2023/060665, filed Apr. 24, 2023, and entitled “Apparatus, System and Method for Radioisotope Production Using Electrons,” the entire disclosure of which is incorporated herein by reference.

### FIELD

Various embodiments are described herein that generally relate to apparatuses, systems and methods for the production of radioisotopes using electrons.

### BACKGROUND

Radiopharmaceuticals are a group of pharmaceutical drugs containing radioisotopes. Radiopharmaceuticals may be applied for both diagnostic and therapeutic purposes depending on the radioisotopes used. Devices and methods for producing radioisotopes have been in use for several decades, and new techniques that solve problems or improve yields continue to be developed.

For example, a nuclear reactor can be employed to produce a wide range of isotopes. These isotopes may be extracted as a fission product or may be produced by neutron capture on a target material.

A cyclotron is an accelerator used to accelerate heavy charged particles such as protons, deuterons, and heavier ions. When these particles collide with a target, the consequent nuclear reaction resulting in the production of various radionuclides.

More recently, electron accelerators have been investigated as a potential way to produce radioisotopes. However, there is a need for improved approaches to use these electron accelerators in a more effective manner to be able to industrially produce radioisotopes.

### SUMMARY OF VARIOUS EMBODIMENTS

In an aspect, in accordance with the teachings herein, there is provided at least one embodiment of an apparatus for producing one or more radioisotopes, wherein the apparatus includes: a converter assembly including a high Z material configured to receive an electron beam to generate a photon beam by bremsstrahlung radiation; and a target assembly including a target material configured to receive the photon beam from the converter assembly to produce the one or more radioisotopes.

In at least one embodiment, the apparatus includes: a converter assembly including a high Z material configured to receive an electron beam to generate a photon beam by bremsstrahlung radiation; and a target assembly including a target material configured to receive the photon beam from the converter assembly to produce the one or more radioisotopes.

In at least one embodiment, the apparatus further includes a beam window located upstream of the converter and target assemblies, wherein the beam window is near an end portion of a beam line and is configured to isolate the beam line from downstream elements and to transmit the electron beam to the converter assembly during use.

In at least one embodiment, the beam window is hermetically sealed to maintain a vacuum or near vacuum pressure in the apparatus upstream of the beam window.

In at least one embodiment, the beam window includes two sheets with a gap therebetween.

In at least one embodiment, the gap is preferably about 1 mm.

In at least one embodiment, the beam window is coupled to a conduit for receiving a coolant between the two sheets during use.

In at least one embodiment, the coolant includes Helium or water.

In at least one embodiment, the beam window is made using titanium or Havar.

In at least one embodiment, the beam window is configured to receive a coolant during use to be cooled the beam window is configured to receive a coolant during use to be cooled to transmit the electron beam having a current up to about 1 mA.

In at least one embodiment, the beam window is configured to transmit the electron beam with a diameter from about 0.5 cm to about 2 cm, inclusive.

In at least one embodiment, the converter assembly is integrated at an end of the beam line of the apparatus.

Alternatively, in at least one embodiment, the converter assembly and the target assembly are located in a common housing.

In at least one embodiment, the converter assembly includes a housing including one or more converter plates having the high Z material.

In at least one embodiment, the high Z material includes Palladium, Rhodium, Tantalum, Tungsten, any compound of Palladium, any compound of Rhodium, any compound of Tantalum, any compound of Tungsten, any alloy of Palladium, any alloy of Rhodium, any alloy of Tantalum, or any alloy of Tungsten.

In at least one embodiment, Z is a number of protons in atoms of the high Z material where Z ranges from about 20 to about 90, inclusive.

In at least one embodiment, the target assembly includes at least one target plate including the target material.

In at least one embodiment, the target material includes Zinc-68, Radium-226, Molybdenum-100, Titanium-48, any compound of Zinc-68, any compound of Radium-226, any compound of Molybdenum-100, any compound of Titanium-48, an alloy of Zinc-68, an alloy of Radium-226, an alloy of Molybdenum-100 or an alloy of Titanium-48.

In at least one embodiment, the target material is hermetically sealed by a surrounding material.

In at least one embodiment, the surrounding material includes copper, aluminum, any alloy of copper, or any alloy of aluminum.

In at least one embodiment, the apparatus further includes a beam dump including a first shielding assembly and a second shielding assembly that are releasably couplable to one another and surround the converter and target assemblies, wherein the first and second shielding assemblies are configured to attenuate excess particles that do not contribute to generation of the one or more radioisotopes during usage of the apparatus.

In at least one embodiment, the beam dump further includes an aluminum block that is located downstream of the target assembly and is surrounded by one of the shielding assemblies, the aluminum block being configured to attenuate the excess particles that do not contribute to generation of the one or more radioisotopes during usage of the apparatus.

In at least one embodiment, the beam dump further includes a blanket of polyethylene located at an outer portion of the beam dump to attenuate neutrons that escape from the beam dump.

In at least one embodiment, the beam dump includes materials having geometries selected to reduce photon dose rate by more than about five orders of magnitude and/or neutron dose rate by more than about four orders of magnitude.

In at least one embodiment, the excess particles include excess photons, excess electrons and/or excess neutrons.

In at least one embodiment, the first and/or second shielding assemblies are formed of aluminum, polyethylene (PE), lead, and/or steel.

In at least one embodiment, the first and/or second shielding assemblies include a plurality of shielding sheets at outer portions thereof.

In at least one embodiment, the first and second shielding assemblies include an outer shielding assembly and an inner shielding assembly.

In at least one embodiment, the outer shielding assembly is formed of PE.

In at least one embodiment, the inner shielding assembly is formed of steel.

In at least one embodiment, the outer shielding assembly further includes a first outer shielding assembly and a second outer shielding assembly.

In at least one embodiment, the inner shielding assembly further includes a first inner shielding assembly and a second inner shielding assembly.

In at least one embodiment, the beam dump further includes a lead shielding assembly that is located upstream of the converter and target assemblies and is configured to reduce backscattered radiation produced in the converter and target assemblies during use.

In at least one embodiment, the apparatus further includes an aperture assembly that is upstream of the converter assembly, the aperture assembly being configured to stop any electrons of the electron beam that are not travelling through an aperture of the aperture assembly.

In at least one embodiment, the apparatus further includes a beam shaping assembly that is downstream of the aperture assembly and is configured to adjust an angular divergence or direction of the electron beam.

In at least one embodiment, the beam shaping assembly includes a scanning electromagnet that is operated to apply a sweeping pattern to sweep the electron beam so that the swept electron beam covers a larger surface area of the converter assembly compared to an area of the electron beam.

In at least one embodiment, the beam shaping assembly includes a scattering assembly that includes a scattering component that is configured to increase an angular divergence of the electron beam.

In at least one embodiment, the scattering assembly includes a shaft that is coupled to a drive belt and the scattering component is mounted to the shaft so that during operation the drive belt imparts rotational motion to the shaft and the scattering component to change a location of the scattering component that receives the electron beam to reduce overheating of the scattering component.

In at least one embodiment, the scattering component is a foil made from Cobalt, Titanium, Tantalum, Molybdenum, any alloy of Cobalt, any alloy of Titanium, any alloy of Tantalum, or any alloy of Molybdenum.

In another aspect, in accordance with the teachings herein, there is provided at least one embodiment of a system for producing a radioisotope including: an accelerator assembly for producing an electron beam, and an apparatus for producing one or more radioisotopes, where the apparatus is defined according to any one of the embodiments described herein.

In another aspect, in accordance with the teachings herein, there is provided at least one embodiment of a method for producing at least one radioisotope by using one of the system embodiments described herein, wherein the method includes: selecting converter and target materials used for the converter and target assemblies based on the at least one radioisotope to be created; determining operating parameters of the system for generating the at least one radioisotope; and operating the system according to the determined operating parameters to generate the at least one radioisotope at the target material.

In at least one embodiment, the method includes selecting the material for the converter sheets from Palladium, Rhodium, Tantalum, Tungsten, any compound of Palladium, any compound of Rhodium, any compound of Tantalum, any compound of Tungsten, any alloy of Palladium, any alloy of Rhodium, any alloy of Tantalum, or any alloy of Tungsten.

In at least one embodiment, the method includes selecting the material used in the target plates from Zinc-68, Radium-226, Molybdenum-100, Titanium-48, any compound of Zinc-68, any compound of Radium-226, any compound of Molybdenum-100, any compound of Titanium-48, an alloy of Zinc-68, an alloy of Radium-226, an alloy of Molybdenum-100 or an alloy of Titanium-48.

In at least one embodiment, the method includes selecting an energy of the electron beam within a range of about 10 MeV to about 50 MeV, inclusive.

In at least one embodiment, the method includes selecting a beam diameter for the electron beam within a range of about 0.5 mm to about 15 mm, inclusive.

In at least one embodiment, the method includes selecting a beam current of about 1 mA for the electron beam, which corresponds to a beam power of the electron beam being about 40 kW when the beam energy is about 40 MeV.

In another aspect, in accordance with the teachings herein, there is provided at least one embodiment of an apparatus for producing one or more radioisotopes, wherein the apparatus includes: a converter assembly including a high Z material configured to receive an electron beam to generate a photon beam by bremsstrahlung radiation; a target assembly including a target material configured to receive the photon beam from the converter assembly to produce the one or more radioisotopes; and a beam window located upstream of the converter and target assemblies, wherein the beam window is near an end portion of a beam line and is configured to isolate the beam line from downstream elements and to transmit the electron beam to the converter assembly during use.

The beam window may be further defined according to any one of the embodiments described herein.

In another aspect, in accordance with the teachings herein, there is provided at least one embodiment of an apparatus for producing one or more radioisotopes, wherein the apparatus includes: a converter assembly including a high Z material configured to receive an electron beam to generate a photon beam by bremsstrahlung radiation; a target assembly including a target material configured to receive the photon beam from the converter assembly to produce the one or more radioisotopes; and a beam dump including a first shielding assembly and a second shielding assembly that are releasably couplable to one another and surround the converter and target assemblies, wherein the first and second shielding assemblies are configured to attenuate excess particles that do not contribute to generation of the one or more radioisotopes during usage of the apparatus and wherein the first and second shielding assemblies are detached for accessing the converter and/or target assemblies.

The beam dump may be further defined according to any one of the embodiments described herein.

In another aspect, in accordance with the teachings herein, there is provided at least one embodiment of an apparatus for producing one or more radioisotopes, wherein the apparatus includes: a converter assembly including a high Z material configured to receive an electron beam to generate a photon beam by bremsstrahlung radiation; a target assembly including a target material configured to receive the photon beam from the converter assembly to produce the one or more radioisotopes; and a beam shaping assembly that is upstream of the converter assembly and is configured to adjust an angular divergence or direction of the electron beam.

The beam shaping assembly may be further defined according to any one of the embodiments described herein.

Other features and advantages of the present application will become apparent from the following detailed description taken together with the accompanying drawings. It should be understood, however, that the detailed description and the specific examples, while indicating preferred embodiments of the application, are given by way of illustration only, since changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

For example, the following drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size, while other figures may depict the same components on a larger scale for the sake of clarity.

FIGS. 1A-1F are block diagrams of example embodiments of a system for producing a radioisotope using an apparatus that is in accordance with the teachings herein.

FIG. 2 shows an example of an apparatus (the shielding is not shown) for producing radioisotopes of the present application, in accordance with various embodiments.

FIG. 3A shows an example of an aperture assembly within the apparatus of FIG. 2, in accordance with various embodiments.

FIG. 3B shows an example of a beam shaping assembly including a scattering foil for use with the apparatus of FIG. 2, in accordance with various embodiments.

FIG. 3C shows a cross-sectional view of the scattering foil of FIG. 3B across plane 3C-3C of FIG. 3B, in accordance with various embodiments.

FIG. 4A shows an example of an XY slit system and a converter assembly for use with the apparatus of FIG. 2, in accordance with various embodiments.

FIG. 4B shows a cross-sectional view of the XY slit system taken along plane 4B-4B of FIG. 4A, in accordance with various embodiments.

FIG. 5 illustrates a magnified view of the end of the beam line and the converter and target assemblies of the apparatus shown in FIG. 2.

FIG. 6A shows a portion of another example apparatus for producing radioisotopes in accordance with the teachings herein.

FIG. 6B shows a magnified view of a portion of the apparatus of FIG. 6A.

FIG. 7A illustrates an example of a radioisotope production environment, in accordance with various embodiments.

FIGS. 7B-7C show a side view and a top view, respectively, of an example apparatus for producing radioisotope, in accordance with various embodiments.

FIG. 8 shows a flow chart of an example embodiment of a method for producing radioisotopes in accordance with the teachings herein.

Further aspects and features of the example embodiments described herein will appear from the following description taken together with the accompanying drawings.

### DETAILED DESCRIPTION OF THE EMBODIMENTS

The description that follows describes, illustrates, and provides examples of one or more embodiments of the present application in accordance with the teachings herein. This description is not provided to limit the present application to the embodiments described herein, but rather to explain and teach the principles in order to enable one of ordinary skill in the art to understand these principles and, with that understanding, be able to apply them to practice not only the embodiments described herein, but also other embodiments that may come to mind in accordance with these principles. The scope of the present application is intended to cover all such embodiments that may fall within the scope of the claims, either literally or under the doctrine of equivalents.

Furthermore, the claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled”, or “coupling” as used herein can have several different meanings depending in the context in which these terms are used. For example, the terms coupled, or coupling can have a mechanical, electrical or fluidic connotation. For example, as used herein, the terms coupled or coupling can indicate that two elements or devices can be directly connected to one another or connected to one another through one or more intermediate elements or devices via an electrical signal, an electrical connection, a fluidic pathway or a mechanical element depending on the particular context.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any operable combination thereof. Accordingly, the term “any operable combination thereof” is meant to cover any operable combination of the elements which precede the phrase. For example, the phrase “A, B, C, D or any operable combination thereof” includes A; B; C; D; A and B; A and C; A and D; B and C; B and D; C and D; A, B and C; A, B and D; A, C and D; B, C and D as well as A, B, C and D assuming that all such combinations are operable (i.e., they can be used together in practice in a working embodiment).

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

A portion of the example embodiments of the systems, devices, or methods described in accordance with the teachings herein may be implemented as a combination of hardware and/or software. For example, a portion of the embodiments described herein may be implemented, at least in part, by using one or more computer programs, executing on one or more programmable devices including at least one processing element, and at least one data storage element (including volatile and non-volatile memory). These devices may also have at least one input device (e.g., a keyboard, a mouse, a touchscreen, other input elements or any operable combination thereof) and at least one output device (e.g., a display screen, a printer, a wireless radio, other output elements or any operable combination thereof) depending on the type of device.

It should also be noted that there may be some elements that are used to implement at least part of the embodiments described herein that may be implemented via software that is written in a high-level procedural language such as object-oriented programming. The program code may be written in C, C⁺⁺ or any other suitable programming language and may include modules or classes, as is known to those skilled in object-oriented programming. Alternatively, or in addition thereto, some of these elements implemented via software may be written in assembly language, machine language, or firmware as needed.

At least some of the software programs used to implement at least a portion of at least one of the embodiments described herein may be stored on a storage media or a device that is readable by a general or special purpose programmable device. The software program code, when read by the programmable device, configures the programmable device to operate in a new, specific and predefined manner in order to perform at least one of the methods described herein.

Any device described herein that executes software instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

A radionuclide (also referred to herein interchangeably as a radioactive nuclide, a radioisotope, or a radioactive isotope) is a nuclide that has excess nuclear energy, making it unstable. This excess energy can be emitted from the nucleus, for example, as gamma radiation; transferred to one of its electrons to release it as a conversion electron; or used to create and emit a new particle from the nucleus, such as, for example, an alpha particle or a beta particle. During those processes, the radionuclide is said to undergo radioactive decay. Radiation is often easily traceable and can cause changes in the substance it falls upon. These special attributes make radioisotopes useful in medicine, industry, and other areas.

Most radioisotopes are artificially produced using nuclear reactors or particle accelerators. The generated radionuclide is then processed via chemical means to bring it into the desired chemical form. However, there may be some challenges regarding the efficiency of creating the radioisotopes. In addition, conventional equipment may have safety and maintenance concerns regarding the design of the beam line and the chamber within which the equipment used to generate the radioisotopes is housed.

Bremsstrahlung is electromagnetic radiation produced by the deceleration of a charged particle when deflected by another charged particle, and the typical interaction is the deceleration of an electron by an atomic nucleus. The moving particle loses kinetic energy, which is converted into radiation (i.e., photons), thus satisfying the law of conservation of energy. Bremsstrahlung has a continuous spectrum, which becomes more intense and whose peak intensity shifts toward higher energy as the energy of the decelerated particles increases. The terms bremsstrahlung and bremsstrahlung radiation are used herein interchangeably. Bremsstrahlung radiation may also pose some safety challenges in terms of stray photons which are not used for the generation of the radioisotope.

The present application provides at least one embodiment of an apparatus, system, and method for producing radioisotopes. The radioisotopes may generally be produced by bombarding an isotope production target with bremsstrahlung photons. The bremsstrahlung photons may originate from a converter assembly due to impingement thereon by an electron beam. The electron beam is typically generated from an electron beam source. A method of producing radioisotopes may use one of the embodiments of the apparatuses and systems described herein.

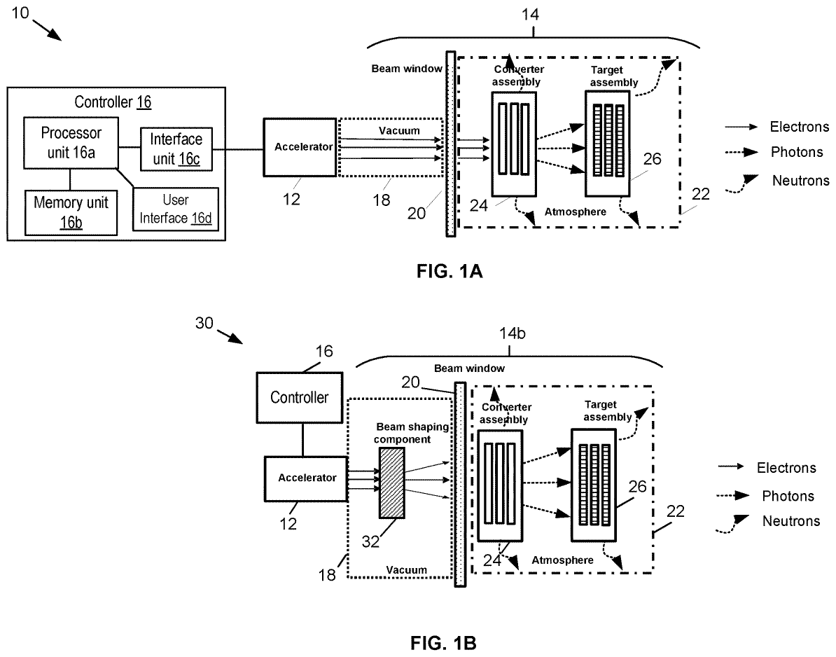

Referring now to FIG. 1A, shown therein is an example embodiment of a system 10 for producing one or more radioisotopes in accordance with the teachings herein. The system 10 generally includes an accelerator 12 that is coupled to an apparatus 14 for producing one or more radioisotopes and a controller 16. The accelerator 12 may also be referred to as an accelerator assembly. The controller 16 controls the operation of the accelerator 12 for generating an electron beam that is provided to the apparatus 14 via a beam line 18. The beam line 18 may be a metallic pipe or other conduit that is maintained at vacuum or near vacuum pressure so that the electron beam is transmitted to the apparatus 14 with an acceptable amount of scatter.

There are various embodiments that may be used to implement the apparatus 14. However, generally the apparatus 14 for producing one or more radioisotopes includes: (1) a converter assembly 24 including a high Z material configured to receive the electron beam and generate a photon beam by bremsstrahlung radiation, and (2) a target assembly 26 including a target material configured to receive the photon beam from the converter assembly 24 to produce the one or more radioisotopes. The converter and target assemblies 24 and 26 are located in one or more housings 22 that may be maintained at an ambient pressure, for example, a pressure of about 1 atmosphere.

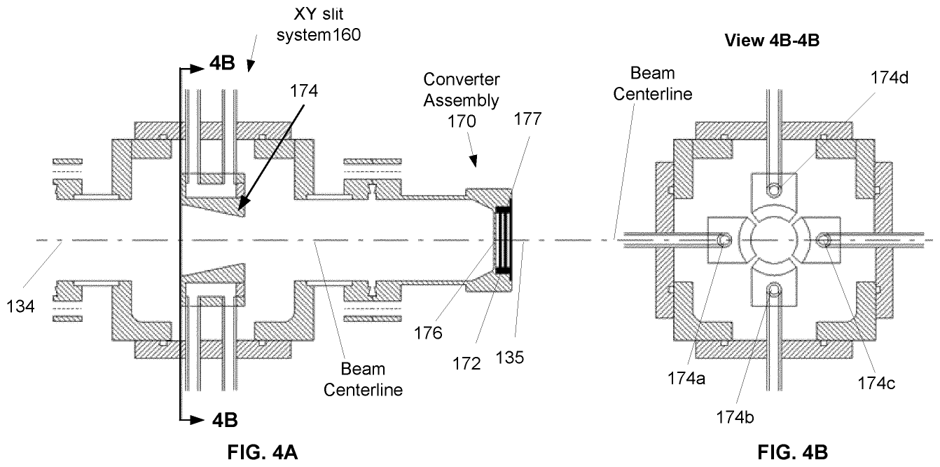

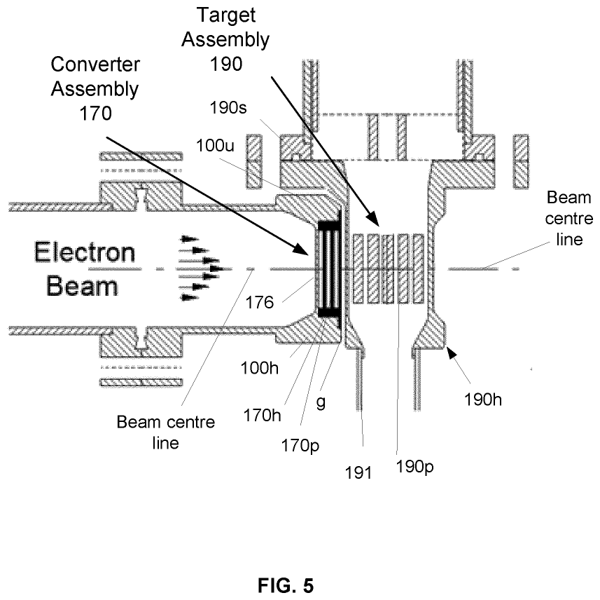

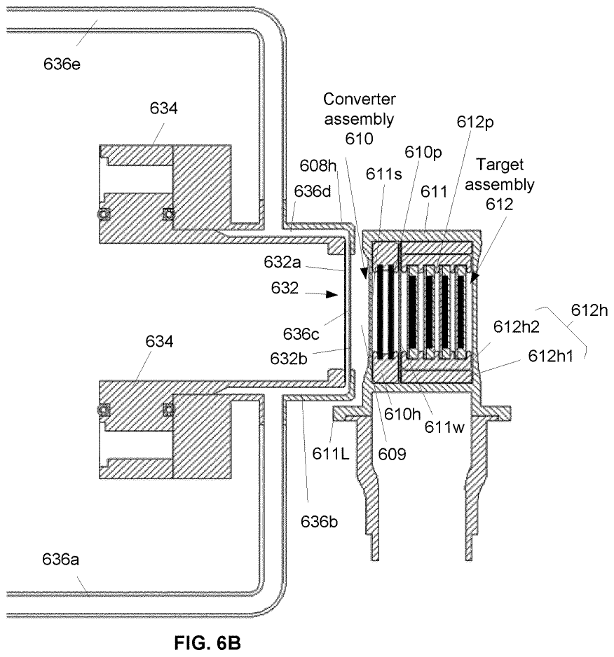

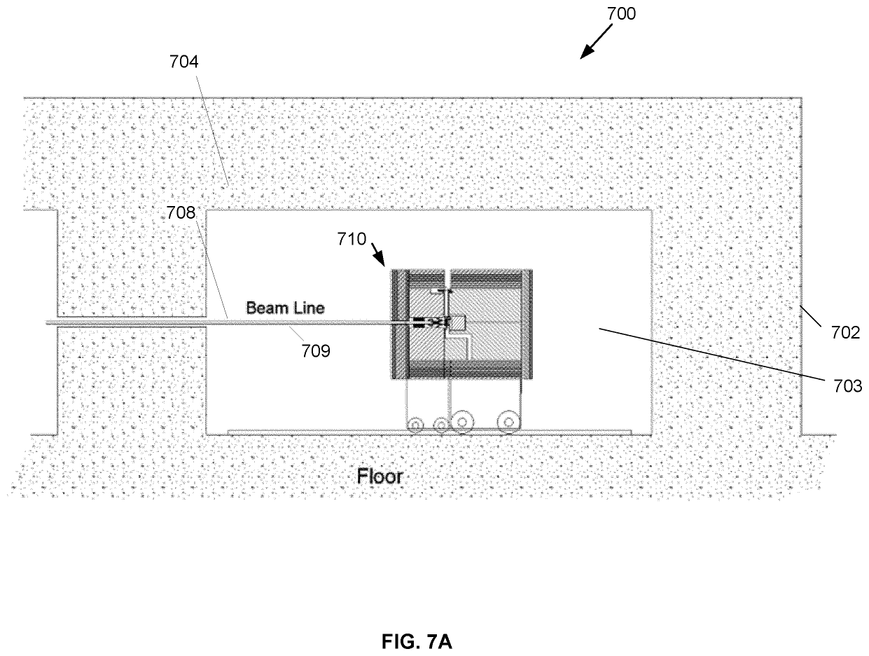

In at least one embodiment, the converter assembly and the target assembly are positioned in the same housing in the apparatus 14, an example of which is shown in FIGS. 6A-6B. Alternatively, in at least one embodiment, the converter assembly 24 and the target assembly 26 may be positioned in separate housings within the apparatus 14. For example, this may occur in an alternative embodiment of the apparatus shown in FIGS. 6A-6B, where the converter assembly 24 and the target assembly 26 may be in physically separate sub-housings. This may allow for different fluid to flow in both of these assemblies. In another example, such as that shown in FIG. 4A, the converter assembly 24 may be integrated into the end of the beam line and be in a different physical housing than the target assembly 26.

The converter assembly 24 generally includes a high Z material that is used to convert incident electrons into a photon beam including a plurality of photons and having a second solid angle that is larger than the solid angle of the electron beam provided to the converter assembly 24. As described herein, a high Z material refers to a material including a chemical element with a high atomic number (Z) of protons in the nucleus. As described herein, a material having a high atomic number Z includes materials having Z that ranges from about 20 to about 90. Examples of high Z materials that may be used include, but are not limited to, Palladium, Rhodium, Tantalum, Tungsten, any compound thereof, any alloy thereof or any operable combination thereof. Persons of ordinary skill in the art will recognize that other materials having different atomic numbers may be used, and the aforementioned are provided as examples. Generally, the high Z material may be selected to have a high melting point, a low induced activity, a high density so that one can have “tight” geometry in that converter plates made using this material are relatively thin, and to not react with water.

The converter assembly 24 may generally includes a plurality of converter plates, and each one of the plates may include the high Z material. Examples of these converter plates are shown in FIGS. 4A and 6B (e.g., converter plate 610p). The converter plates can be any suitable shape that may be placed within the converter assembly. In at least one embodiment, a converter plate having the high Z material in the converter assembly 24 may have a thickness of about 0.1 mm to about 10 mm, inclusive. For example, in at least one embodiment, at least one of the sheets in the converter assembly 24 may have a thickness of about 0.1 mm to about 10 mm including, for example, about 0.1 mm, about 0.5 mm, about 1 mm, about 2 mm, about 5 mm, about 10 mm, or any other amount within the aforementioned range.

The target assembly 26 generally includes a target material that is configured to receive the photons from the photon beam produced by the converter assembly 24 to produce the one or more radioisotopes. The target material is selected based on the radioisotope that is to be produced. For example, in some embodiments, the target material may include, but is not limited to, Zinc-68, Radium-226, Molybdenum-100, Titanium-48, any compound thereof, any alloy thereof or any operable combination thereof.

In some embodiments, the radioisotope produced by the apparatus of the present application may include, but is not limited to, Copper-67 (Cu-67, ⁶⁷Cu), Actinium-225 (Ac-225, ²²⁵Ac), Molybdenum-99 (Mo-99, ⁹⁹Mo), or Scandium-47 (Sc-47, ⁴⁷Sc), or any other radioisotope, depending on the type of target material that is used in the target assembly 26.

For instance, in one non-limiting example, in at least one embodiment, the target material includes Radium-226, or any compound or alloy thereof, for producing the radioisotope Actinium-225.

As another non-limiting example, in at least one embodiment, the target material includes Zinc-68, or any compound or alloy thereof, for producing radioisotope Copper-67.

As another non-limiting example, in at least one embodiment, the target material includes Molybdenum-100, or any compound or alloy thereof, for producing radioisotope Molybdenum-99.

As another non-limiting example, in at least one embodiment, the target material includes Titanium-48, or any compound or alloy thereof, for producing radioisotope Scandium-47.

In at least one embodiment, the target material may have a thickness of about 0.1 mm to about 10 mm. In at least one embodiment, the target assembly 26 includes several plates where at least one or more of the plates include the target material. The plates can be any suitable shape that may be placed within the target assembly 26. In at least one embodiment, the plates of the target assembly 26 that contain target material may have a thickness that ranges from about 0.1 mm to about 10 mm, inclusive, including, for example, about 0.1 mm, about 0.5 mm, about 1 mm, about 2 mm, about 5 mm, about 10 mm, or any amount within the aforementioned range.

In some embodiments, the target material is hermetically sealed by a surrounding material. For example, in some cases, the target material may react with water, or the target material may have a powder form and in these cases the target material is generally sealed. In such cases, the seal may be broken when the harvesting the created radioisotopes. The surrounding material that encapsulates the target material may include a low Z material that is resistant to radiation induced chemistry with the coolant. For example, the encapsulating material may provide a seal around the target material. Examples of low Z material may include a Z of about 4 to about 13. Examples of surrounding material include, but are not limited to, beryllium and aluminum and any alloy thereof.

In at least one embodiment, the apparatus 14 further includes a beam window 20. The beam window 20 is generally located at the end of the beam line 18 and provides a hermetic seal for the beam line 18. This allows components that are downstream of the beam window 20 to be removed for maintenance, for example, without having to disassemble any components that are upstream of the beam window 20 while also isolating the vacuum environment of the beam line 18. An example of the beam window 20 is shown in FIGS. 6A-6B. The beam window 20 may also be referred to as an electron beam window.

The controller 16 may include a processor unit 16a, a memory unit 16b, an interface unit 16c, a user interface 16d, and a power unit 16e. The controller 16 also generally includes a power unit (not shown) to provide power to various components of the controller 16 as is known by those skilled in the art. As stated previously, the controller 16 is used to control the operation of the accelerator 12 by sending control signals thereto. In at least one embodiment, these components may be integrated with the accelerator. In other embodiments, the controller 16 may include other components or some of the components may be combined together.

The processor unit 16a can be any suitable processor, controller, or digital signal processor that can provide sufficient processing power. For example, the processor unit 16a may include a standard processor, such as an Intel or AMD processor. Alternatively, there may be a plurality of processors that are used by the processor unit 16a, and these processors may function in parallel and perform certain functions. Therefore, the processor unit 16a is considered as having at least one processor.

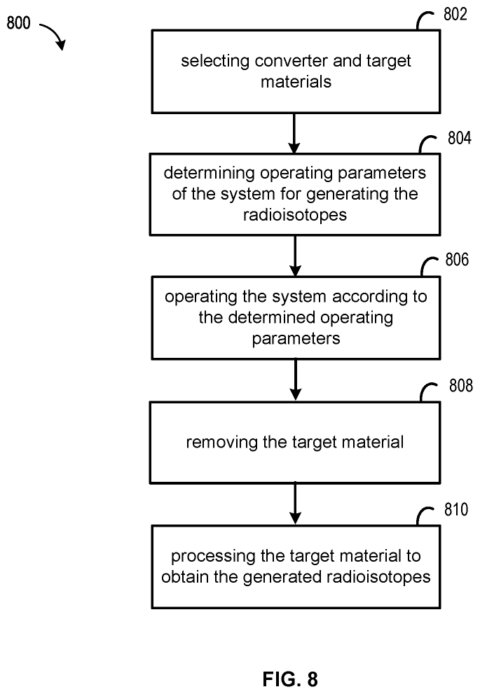

The memory unit 16b includes various software programs for the operation of the controller 16, such as software programs having instructions for implementing an operating system and programs that when executed, configures the processor unit 16a to operate in a particular manner to implement various functions for the controller 16. For example, the software programs may include a control program that allows a user to enter various control parameters via the user interface 16d or the control parameters may be preprogrammed. The control parameters may be used so that the controller 16, when executing the control program, generates control signals that are provided to the accelerator 12 via the interface unit 16c so that the accelerator 12 generates electron beams according to predefined parameters so that the generated electron beams have a selected energy, beam current and spatial distribution which results in the generation of certain radioisotopes depending on the materials used for the converter and target plates. For example, the control program may be used to implement certain steps of method 800 shown in FIG. 8 for generating one or more radioisotopes.

In at least one embodiment, monitoring software programs may be used to configure the controller 16 to monitor the operation of the apparatus 14 when the monitoring software programs are executed. For example, certain physical portions of the apparatus 14 may be monitored to ensure that the accelerator 12 is operating according to acceptable operating conditions so that the apparatus 14 is not damaged. This may be done by monitoring temperature and/or current for certain elements of the apparatus 14 to make sure that the measured temperature and/or measured current are within acceptable limits. If this is not the case, then the controller 16 may send a signal to stop the generation of the electron beam by the accelerator 12.

The interface unit 16c can be any interface that allows the controller 16 to receive data (e.g., measurements) from the accelerator 12 or sensors used in the apparatus 14 or send control signals to the accelerator 12. In some cases, the interface unit 16c can include one or more input and output ports, an analog to digital converter, and a digital to analog converter for sending control signals and/or receiving data. The interface unit 16c may also include components that allow the controller 16 to communicate with other electronic devices. Accordingly, the interface unit 16c may include a network adapter for an Internet connection, a Local Area Network (LAN) connection, an Ethernet connection, or other network connection. Alternatively, or in addition, the interface unit 16c may also include a wireless unit such as a radio that communicates utilizing CDMA, GSM, GPRS, or another suitable communication protocol.

The user interface 16d may be used to display certain information to a user and receive input data including control parameters from the user. Alternatively, the user interface 16d may include input devices that a user can use to provide data or control inputs to the controller 16. These input devices include a keyboard, a mouse, a touchscreen, other suitable input devices or any operable combination thereof. The user interface can also include devices to provide an output to the user, such as a display, a printer, a speaker, other suitable output devices or any combination thereof.

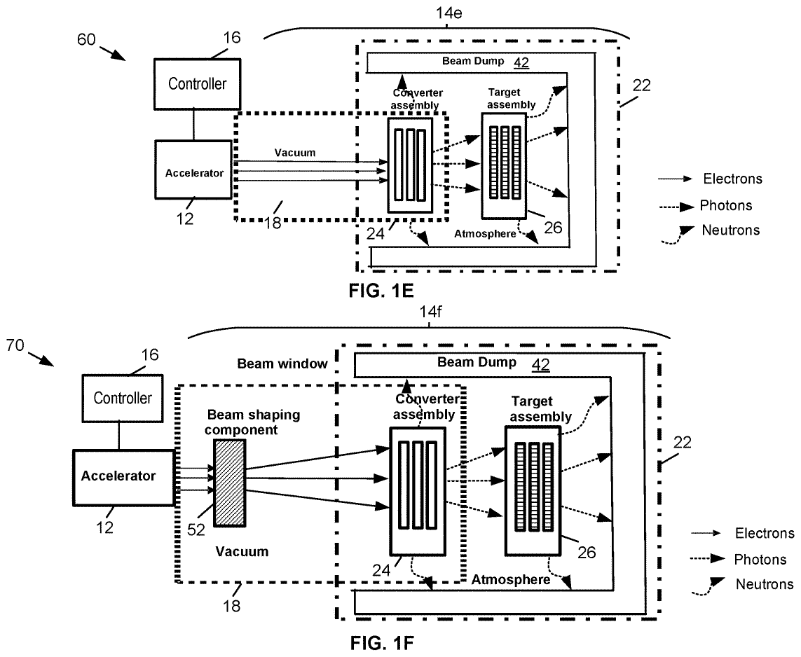

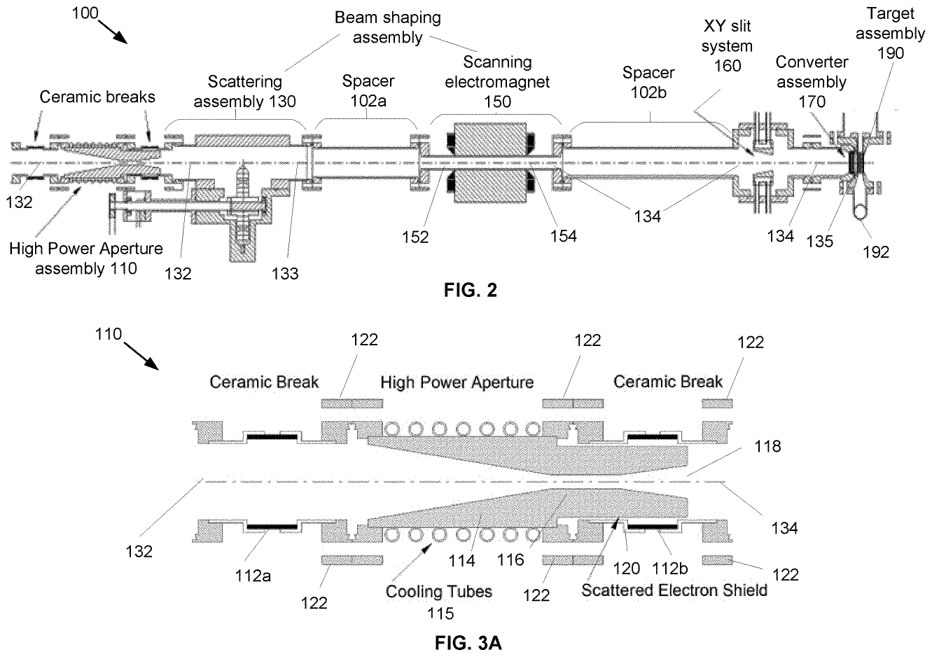

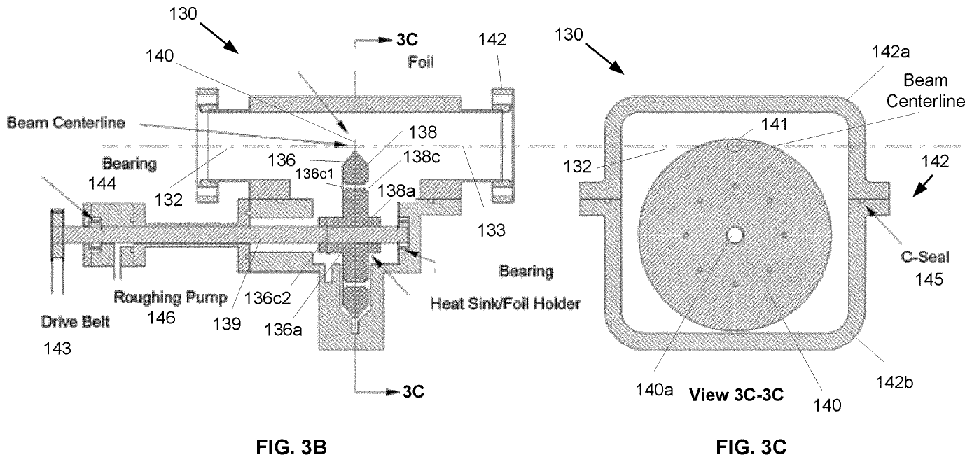

Referring now to FIG. 1B, shown therein is another example embodiment of a system 30 for producing one or more radioisotopes in accordance with the teachings herein. The system 30 generally includes the same elements as the system 10 but now includes an apparatus 14b with a beam shaping assembly 32 which may be used to modify certain characteristics of the electron beam, such as the spatial distribution of the electron beam, before it impinges the convertor assembly 24. This may be done so that the modified electron beam is spread over a larger area of the beam window 20 and subsequently the converter assembly 24 to prevent these elements from overheating compared to situations in which they receive a more concentrated electron beam. An example of a beam shaping assembly is shown in FIGS. 3B-3C. In some embodiments the beam shaping assembly may be optional as described further below.

Referring now to FIG. 1C, shown therein is another example embodiment of a system 40 for producing one or more radioisotopes in accordance with the teachings herein. The system 40 generally includes the same elements as the system 10 but now includes an apparatus 14c with a beam dump 42 that is configured to absorb excess particles that do not contribute to the generation of radioisotope(s) in the apparatus 14c. The beam dump 42 may also be referred to as a shielding assembly. For example, in some cases, the operation of some embodiments described herein may produce excess particles that may include, but are not limited to, excess electrons, excess photons and/or excess neutrons. For example, excess electrons may come from the electron beam or are generated due to the impingement of the high Z material by the electron beam. As another example, excess photons and/or excess neutrons may come from the impingement of the high Z material by the electron beam or are generated from the impingement of the target material by photons.

The beam dump 42 is configured (i.e., designed and shaped) to substantially surround and enclose the converter assembly 24 and the target assembly 26 and a portion of the apparatus in which the electron beam travels through on the way to the converter assembly 24. For example, there are some gaps and/or conduits in the beam dump 42 to allow for the location of the converter and target assemblies 24 and 26 and portion of the apparatus upstream of the converter assembly 24 as well as other components such as portions of a cooling system such as the tubes/conduits that carry a coolant.

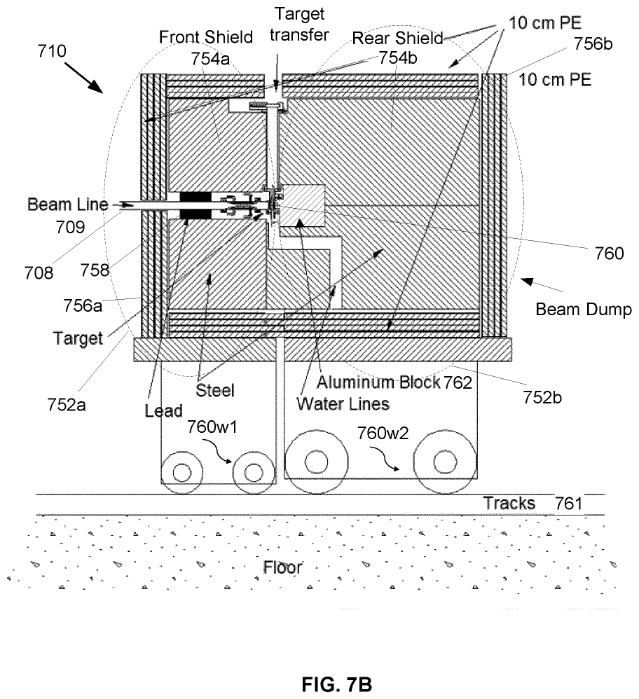

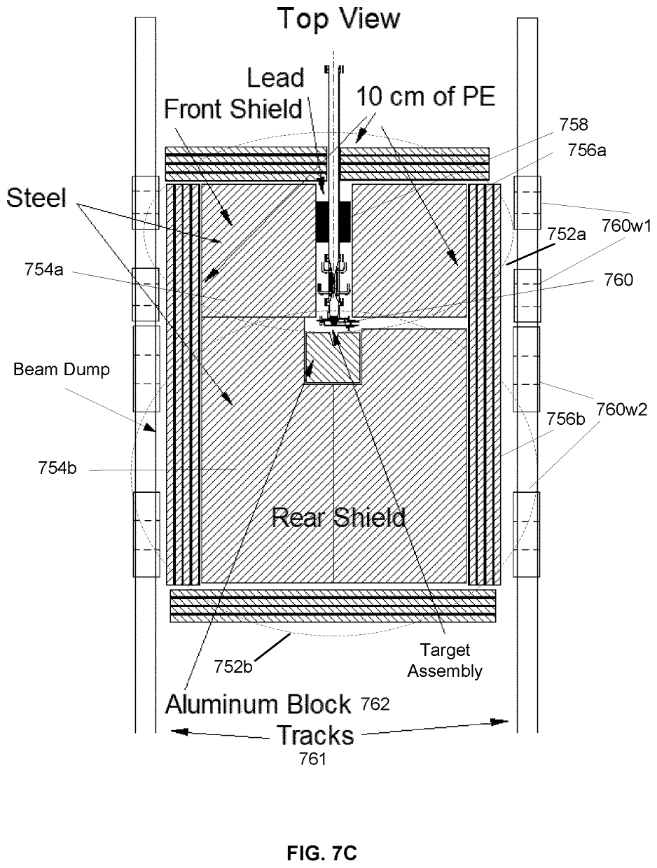

In one aspect, the beam dump 42 is made of certain materials in certain locations that are better able to absorb certain byproducts of the radioisotope generation process, as will be explained below, with reference to FIGS. 7B and 7C. For example, portions of the beam dump 42 is generally made using any suitable material known in the art such as, but not limited to, aluminum, steel, lead water, polyethylene, or any operable combination thereof, for example, where the material is able to absorb a suitable level of excess electrons, excess photons and/or excess neutrons. For example, in at least one embodiment the beam dump 42 may include an aluminum block as well as a plurality of shielding sheets made of the aforementioned shielding materials.

In another aspect, the beam dump 42 may include two or more blocks that are removably coupled to one another thereby allowing the components of the beam dump 42 to be separated such that any components of the apparatus that are surrounded by the beam dump 42 may be accessed such as the converter assembly 24 and/or the target assembly 26. For example, the beam dump 42 may be dissembled by removing at least one of the removably attachable beam dump portions to improve physical access to the apparatus components so that these components can be easily inspected and/or replaced if needed. An example of a beam dump 42 having this configuration is shown in FIGS. 7B-7C.

It should be noted that there may be some embodiments in which a beam dump is not used. However, in such embodiments, there may be more shielding/absorption elements that are used to absorb the stray photons and stray neutrons. For example, if there was no shielding or a small amount of shielding, the chamber may have to made using more concrete (e.g., see FIG. 7A) and everything in the chamber will tend to get activated because of the stray photons and neutrons. This may then lead to increased costs when decommissioning the apparatus after use as well as more safety concerns due to the higher level of activation of the elements in the chamber.

In at least one embodiment, the beam dump, i.e., entire shielding assembly, may have various configurations and be made of different types of materials. For example, in at least one embodiment, the beam dump may include steel sections. Alternatively, in at least one embodiment, the beam dump may include a plurality of shielding sheets and the shielding sheets are made of PE or steel. As another example, in at least one embodiment, the shielding assembly may include at least one lead shielding component. FIG. 7B shows an example embodiment of a beam dump that includes these various components.

Referring now to FIG. 1D, shown therein is another example embodiment of a system 50 for producing one or more radioisotopes in accordance with the teachings herein. The system 50 generally includes the same elements as the system 40 but now includes an apparatus 14d with a beam shaping assembly 52 that is configured to spread the area of the electron beam that is incident on the converter assembly 24. The beam shaping assembly 52 may include a scattering component. In at least one embodiment, the scattering component is a scattering foil. In at least one embodiment, the scattering component preferably includes a stiff (e.g., high strength) material that has a high melting point since it will be exposed to the electron beam. Examples of materials that can be used in the scattering component include, but are not limited to, Cobalt, Titanium, Tantalum, Molybdenum, and any operable alloy thereof. In at least one embodiment, the scattering component includes Havar. An example of the beam shaping assembly 52 is shown in FIGS. 3B-3C.

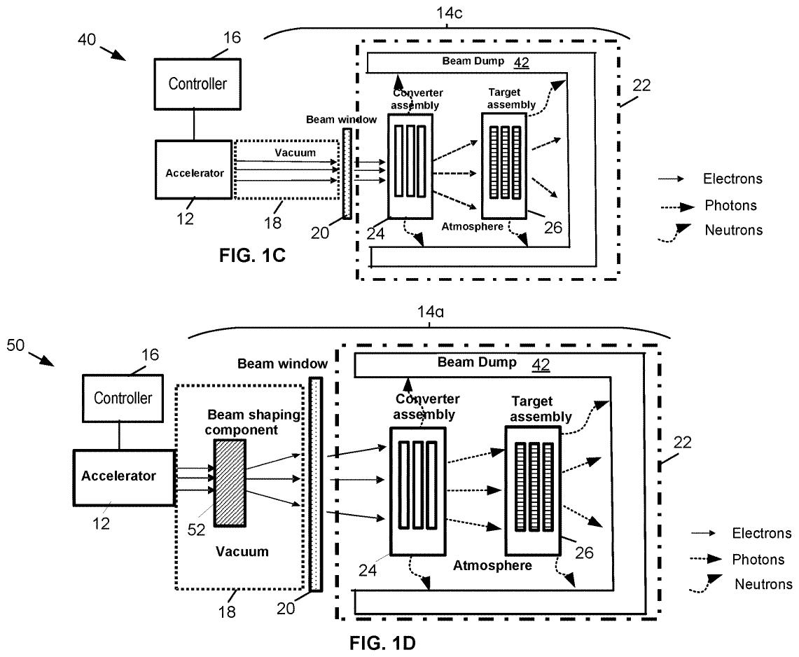

In at least one embodiment, the beam shaping assembly 52 of the apparatus 14d may include a magnet component that is configured to adjust the electron beam. For example, the magnet component may be configured to adjust the direction of the electron beam thereby sweeping the electron beam over a predefined area based on the sweeping pattern to reduce the average power density on that region. An example of the magnet component is shown in FIG. 2.

In at least one embodiment, the beam shaping assembly 52 of the apparatus 14d may include both the scattering component and the magnet component for adjusting the trajectory of the electron beam.

Alternatively, in at least one embodiment, the apparatus 14d may not include the beam shaping assembly 52 but some of the functionality of the beam shaping assembly 52 may be provided by another component of the system 50 such as the accelerator 12. In such embodiments, the accelerator 12 may include magnets that can be operated to provide the same functionality as would otherwise be provided by the scattering component that may be included in the beam shaping assembly 52. For example, some accelerators can provide electron beams with different cross-sections.

In another aspect, provided herein is a system for producing one or more radioisotopes where the system includes: (1) an accelerator assembly for producing an electron beam, and (2) one of the embodiments of the apparatuses described herein.

The accelerator assembly generally includes any suitable accelerator known in the art. In some embodiments, the accelerator is a Linear accelerator (LINAC) or a Rhodotron. Examples of the radioisotopes that can be produced by the system have been described previously.

Referring now to FIG. 1E, shown therein is another example embodiment of a system 60 for producing one or more radioisotopes in accordance with the teachings herein. The system 60 generally includes the same elements as the system 40 but has an apparatus 14e that includes the converter assembly 24, the target assembly 26 and the beam dump 42 but does not include the beam window 20. In such embodiments, the converter assembly 24 may be integrated into the end of the beam line such that outside of housing of the converter and interior to the beamline is at vacuum. Otherwise, the system 60 operates in a similar fashion as the system 40.

Referring now to FIG. 1F, shown therein is another example embodiment of a system 70 for producing one or more radioisotopes in accordance with the teachings herein. The system 70 generally includes the same elements as the system 50 but has an apparatus 14f that includes the converter assembly 24, the target assembly 26, the beam dump 42 and the beam shaping assembly 52 but does not include the beam window 20. In such embodiments, the converter assembly 24 may be integrated into the end of the beam line such that the region that is outside of the housing of the converter and interior to the beamline is at vacuum. Otherwise, the system 70 operates in a similar fashion as the system 50.

Referring now to FIG. 2, shown therein is an example embodiment of an apparatus 100 for producing one or more radioisotopes of the present application, in accordance with the teachings herein. Radioisotope production apparatus 100 includes an aperture assembly 110, a beam shaping assembly including a scattering component (i.e., a scattering assembly 130) and a magnet component (i.e., scanning electromagnet 150), spacers 102a and 102b, an XY slit system 160, a converter assembly 170, and a target assembly 190. These elements are arranged downstream of one another as shown in FIG. 2 and may each have first and second ends with flanges, or other mechanical connectors, that may be used to couple adjacent elements to one another to form seals so as to maintain a vacuum within these elements. Sealing gaskets and sealing material may be used to maintain the vacuum as is known by those skilled in the art.

As explained previously, an electron beam 132 is generated by the accelerator assembly (not shown) and transmitted within a beam line. The beam line is a conduit that is at a very low pressure, such as at vacuum or near vacuum, to allow the electron beam 132 to travel within the assembly 100 with less energy loss and scatter. A first end of the beam line (not shown) is coupled to the output of the accelerator assembly and a second end of the beam line is coupled to the aperture assembly 110 so that the electron beam enters the aperture assembly 110 during use.

The aperture assembly 110 is configured such that it restricts the radial extent of the electron beam 132 as it travels to the scattering assembly 130. Accordingly, the aperture assembly 110 may prevent stray particles, for example, electrons, of the electron beam 132 from passing through to the scattering assembly 130 and damaging downstream components, such as the scanning electromagnet 150 and/or the converter assembly 170. The aperture assembly 110 may further allow for monitoring certain parameters of the beam 132. For example, by monitoring the current at the aperture assembly 110, the quality and consistency of the electron beam 132 can be determined and adjusted. For example, the ceramic breaks are on either end of the aperture assembly 110 so that the aperture assembly 110 is electrically isolated, and one can measure the electron current at the aperture assembly 110. The aperture assembly 110 is typically a high power aperture assembly, so that if the electron beam 132 becomes misaligned and strikes other areas of the aperture assembly 110, the misaligned portions of the electron beam 132 will not damage elements that are downstream of the aperture assembly 110. For example, the aperture assembly 110 may be adapted (as is known to those skilled in the art) to be able to handle a misaligned 20 kW electron beam for short periods of time. This then allows time for the electron beam to be shut off and corrected once it was known to be impinging on portions surrounding the entrance of the aperture assembly 110 rather than travelling relatively straight along the central axis of the aperture assembly 110.

After the electron beam 132 passes through the aperture assembly 110, the electron beam 132 then generally passes through the scattering assembly 130. In at least one embodiment, the scattering assembly 130 may be used to receive the electron beam 132, adjust the electron beam 132 by providing an angular divergence and emit an adjusted electron beam 133. In at least one embodiment, the electron beam 132 may be adjusted such that the electron beam 133 has a wider solid angle than the electron beam 132, as the scattering assembly 130 may spread the area of the electrons of the electron beam 132 into a wider area for the electron beam 133. An example embodiment for the scattering assembly 130 is shown in FIGS. 3B-3C. In at least one embodiment, the scattering assembly 130 may be optional such as, for example, in embodiments in which the functionality of the scattering assembly 130 is provided by another element such as the accelerator.

After the scattering assembly 130, the electron beam 133 passes through a first spacer 102a. The first spacer 102a may serve to increase the distance between the scattering assembly 130 and the scanning electromagnet 150. In some embodiments, however, the first spacer 102a may be omitted from apparatus 100. The first spacer 102a may provide more distance over which the electron beam 133 may spread after leaving the scattering assembly 130 prior to entering into the scanning electromagnet 150. However, there may be a tradeoff versus the thickness for the scattering component material such that the first spacer 102a may be shorter or not needed when the scattering component material has larger thickness.

The scanning electromagnet 150 is generally configured to adjust the electron beam 133 (e.g., position and move the electron beam 133 in a defined pattern) such that a swept electron beam 134 is produced that is moved over an area of the converter assembly 170 that is larger than the area of the electron beam 133. The sweeping of the electron beam 133 can reduce localized heating of the components (e.g., sheets having high Z material) of the converter assembly 170, which can allow the converter assembly 170 to handle a higher current from the swept electron beam 134 without the converter assembly 170 overheating or being damaged. The sweeping pattern that is applied to the electron beam 133 can be alternated by modifying one or more of the signal parameters of the current that is used to drive the scanning electromagnet 150. Different sweeping patterns, such as circular or raster, may be applied by the scanning electromagnet 150. In at least one embodiment, the scanning electromagnet 150 may be optional if the power density can be kept low enough by other means.

In this example embodiment, the scanning electromagnet 150 includes a scanning electromagnet inlet 152 and a scanning electromagnet outlet 154. The scanning electromagnet inlet 152 is configured to receive the electron beam 133. The scanning electromagnet outlet 154 emits the swept electron beam 134.

As shown in the illustrated example embodiment, the apparatus 100 includes a second spacer 102b located between the scanning electromagnet 150 and the XY slit system 160. The second spacer 102b may serve to increase the distance between the scanning electromagnet 150 and the XY slit system 160 which allows for the electron beam to spread over a larger area after having passed through the scanning electromagnet 154. In some embodiments, however, the second spacer 102b may be omitted from apparatus 100. For example, if the magnetic strength of the scanning electromagnet 154 is stronger such that the trajectory of the electron beam 134 can be sufficiently moved over a smaller distance then the spacer 102b may not be needed or a shorter spacer 102b may be used.

The XY slit system 160 is downstream of the spacer 102b and includes X-Y slits which may be used for monitoring the size and position of the electron beam 134 for safety purposes. An example of the XY slit system 160 is shown in FIGS. 4A-4B The converter assembly 170 is downstream of the XY slit system 160. The converter assembly 170 receives the electron beam 134 and the high Z material of the converter assembly 170 then emits photons as part of a photon beam 135. An example of the converter assembly 170 is shown in FIG. 4A. The target assembly 190 is downstream of the converter assembly 170. During use, the photon beam 135 generally impinges on the one or more plates of the target assembly 190 that include material that is selected for producing one or more desirable radioisotopes. An example of the target assembly 712 is shown in FIGS. 6A-6B.

The apparatus 100 generally includes a cooling system that includes cooling tubes or pipes through which a coolant is flowed for preventing overheating of one or more components of the apparatus 100 as is known by those skilled in the art. For example, the cooling system includes cooling tube 192 that is located adjacent the converter and target assemblies 170 and 190 to prevent overheating of these components.

Referring now to FIG. 3A, shown therein is an example embodiment the aperture assembly 110 which may be used within the radioisotope production apparatus 100 of FIG. 2, in accordance with the teachings herein. The aperture assembly 110 allows electrons of the electron beam 132 that are aligned with its aperture to travel to the downstream scattering assembly 130. The aperture assembly 110 also prevents stray particles (e.g., electrons) of the electron beam 132 that are not aligned with the aperture of the aperture assembly 110 from passing to the scattering assembly 130 and damaging downstream components, such as the scanning electromagnet 150 and/or the converter assembly 170. The aperture assembly 110 can further be configured to monitor the electron beam 132. By monitoring the current at the aperture assembly, the quality and consistency of the electron beam 132 can be determined and adjusted, (this may be performed as described previously).

The aperture assembly 110 may include two electrical isolation breaks 112a and 112b, which have a circular shape and are generally made of material that is an electrical insulator. For example, breaks 112a and 112b may be made of ceramic or other suitable materials as is known to those skilled in the art. Breaks 112a and 112b may be used to electrically isolate the aperture assembly 110 from the electron beam source (not shown) and the downstream components of the radioisotope production apparatus 100. Electrically isolating the aperture assembly 110 may permit a measurement to be made of the current due to electrons stopping at the aperture assembly 110. For example, the aperture assembly 110 may be made of a certain material such that electrons having a certain amount of energy are brought to rest within the walls of the aperture assembly. For example, copper may be used in the aperture assembly 110 to stop 40 MeV electrons. The aperture assembly 110 may incorporate cooling tubes 115 which are part of the cooling assembly mentioned previously. The cooling tubes 115 surround a portion of the aperture assembly 110 and a coolant is flowed through the cooling tubes 115 to conduct heat away from the aperture assembly 110.

In at least one embodiment, the aperture assembly 110 may further include a series of flanges 122 for coupling individual components of the aperture assembly 110 to one another or to couple the aperture assembly 110 to upstream and/or downstream components. The aperture assembly 110 includes an aperture inlet 114 for receiving and narrowing the electron beam 132 by stopping electrons that hit the walls of the aperture assembly 110. The aperture inlet 114 incorporates material that is tapered to gradually decrease the size of the passage through the aperture assembly 110. The aperture assembly 110 may also include an aperture throat 116 that may be used to further block stray electrons and confine the electron beam 132 along a smaller conduit through the aperture assembly 110. For example, the aperture throat 116 may reduce the diameter of the electron beam 132 before it exits from an aperture outlet 118 (which may be referred to as an aperture nozzle). The aperture throat 116 may also shield the rest of the apparatus 100 from scattered or stray electrons from the electron beam 132. Accordingly, the aperture throat 116 may be made using a different material that acts to stop electrons that do not travel through the aperture.

Referring now to FIGS. 3B-3C, shown therein is an example embodiment of the scattering assembly 130 that may be used within the apparatus 100, in accordance with various embodiments. FIG. 3C is a cross-sectional view along the plane 3C-3C in FIG. 3B. As seen, the scattering assembly 130 is placed in line with the aperture assembly 110. The scattering assembly 130 is generally configured to receive the electron beam 132 after the electron beam 132 has passed through the aperture assembly 110. The scattering assembly 130 receives the electron beam 132 and emits a modified electron beam 133 due to a scattering component 140, which can alter the path of the electrons in the electron beam 132. The scattering component 140 may be implemented using foil (e.g., a scattering foil) and may be replaceable. For example, the scattering component 140 may be Havar, Ta, Ti, Mo, a Havar alloy, a Ta alloy, a Ti alloy, a Mo alloy or another material as described previously, and may have a thickness on the order of microns or tens of microns such as about 5 um to about 50 um, inclusive (e.g., about 5, about 10, about 15, about 20, about 25, about 30, about 35, about 40, about 45, or about 50 um), or about 5 um to about 20 um, inclusive (e.g., about 5, about 10, about 15, or about 20). In at least one embodiment, the scattering foil may be capable of accepting up to about a 50 kW electron beam with an energy of about 40 MeV and a Full Width at Half Maximum (FWHM) greater than about 0.3 cm.

The thickness of the scattering component 140 can be chosen to spread the area of the electron beam 132 so that the intensity of the resultant electron beam 133 is spread over a larger surface area of the downstream components such as on the converter assembly 170. Altering the thickness of the scattering component 140 changes the number of atomic nuclei therein. The path of the electron beam 132 can thus be altered differently depending on the selected thickness of the scattering component 140 as well as the type of material that is used for the scattering component 140. For example, in at least one embodiment, the shape, thickness and rotation of the scattering component may be selected to provide a rotatable scattering foil that is configured to scatter the electron beam across an area with a diameter greater than about 3 mm.

In at least one embodiment, the scattering component 140 is removably mounted within the scattering assembly 130 so that the scattering component 140 may be removed when it has been damaged or a different thickness is needed and replaced with a new scattering component 140 to ensure that the scattering assembly 130 operates at an acceptable level during use. Accordingly, as shown in this example, the scattering component 140 may be sandwiched between discs 136 and 138 that both have apertures 136a and 138a to receive a shaft 139 so that the discs 136 and 138 may be removably mounted about the shaft 139. The scattering component 140 also has an aperture 140a to receive the shaft 139. The discs 136 and 138 also have channels 136c and 138c that are aligned and sized to receive a fastener, such as a bolt, screw or rivet, for example, to releasably secure the discs 136 and 138 to one another. The disc 136 may also include a channel 136c2 that may be aligned with a corresponding channel in the shaft 139. Accordingly, when the shaft 139 rotates both of the discs 136 and 138 will also rotate.

The scattering assembly 130 has a housing 142 that includes upper and lower shells 142a and 142b that are removably coupled to one another. Accordingly, when the scattering component 140 is to be replaced, the upper shell 142a may be detached from the lower shell 142b, the pin (not shown) holding the disc 136 to the shaft 139 may be removed and the pin (not shown) holding the discs 136 and 138 to one another may be removed so that the discs 136 and 138 may be moved apart from one another. The shaft 139 may then be removed so that the scattering component 140 may be removed and replaced with a new one.

In at least one embodiment, the discs 136 and 138 may be formed of material that has good heat conduction properties, such as Aluminum for example. The scattering component 140 is located between the discs 136 and 138 so that the outer edge of the scattering component 140 extends past the discs 136 and 138. Accordingly, an outer annulus of the scattering component 140 is exposed so that when the scattering component 140 is suspended between the discs 136 and 138 the incoming electron beam 132 impinges upon the portion of the scattering component 140 that is located at the beam centerline of the electron beam 132. Additionally, in the illustrated embodiment, the shaft 139 may be coupled to a drive belt 143 which is in turn coupled to a motor (not shown). During operation, the drive shaft of the motor is rotated, and this rotational motion is translated to the shaft 139 via the drive belt 143. A bearing 144, which may be made from ceramic, may also be used to facilitate rotation of the shaft 139. The discs 136 and 138 are rotatably coupled to the shaft 139 so that the discs 136 and 138 rotate when the shaft rotates 139 which in turn causes the scattering component 140 to rotate. Accordingly, the scattering component 140 may be continuously rotated by the motor via the drive belt 143 during operation. The continuous rotation of the scattering component 140 can prevent the electron beam 132 from continuously impinging on any given portion of the scattering component 140, thereby avoiding excessively heating the scattering component 140 during operation.

The discs 136 and 138 act as mounts and also heat sinks allowing for thermal conduction from the scattering component 140 to dissipate heat therefrom that is created by the electron beam 132 impinging on the scattering component 140. Additionally, cooling may be facilitated by radiative heat transfer to the walls of the radioisotope production apparatus 100.

Turning next to FIG. 3C, a cross-sectional view of the scattering component 130 is shown with the electron beam 132 impinging upon the scattering component 140 at an impingement location 141. While the scattering component 140 is continuously rotated in place, the impingement location 141 generally remains at a constant location relative to the scattering component 140 during operation. The impingement location 141 may be located at the top of the replaceable scattering component 140. The housing components (i.e., shell portions 142a and 142b) may have a housing seal 145 located therebetween so that the housing of the scattering assembly 130 may be hermetically sealed so that the interior of the scattering assembly 130 may be maintained at vacuum or near vacuum. Accordingly, a roughing pump 146 may be used to evacuate air from the interior of the housing 142.

Referring now to FIG. 4A, shown therein is an example embodiment of the XY slit system profiler 160 and the converter assembly 170 that is located downstream of a tapered aperture 174 of the XY slit system 160, in accordance with at least one embodiment. As described previously, the converter assembly 170 receives the electron beam 134 and emits the photon beam 135 which generally impinges upon the target assembly 190, for example, as shown in FIG. 2. The converter assembly 170 is contained within a converter target housing 172. The converter assembly housing 172 may be machined from a material such as, but not limited to, a solid block of titanium alloy or aluminum alloy.

In at least one embodiment, the electron beam 134 may pass through a converter assembly window 176 when the apparatus does not include a beam window. In at least one embodiment, the converter assembly window 176 may be made from a thin, low-density, high-strength material such as, but not limited to, titanium or beryllium, for example. Downstream from the converter assembly window 176 are converter assembly plates 170p that are generally oriented normal to the electron beam 134. The converter assembly plates 170p are used to convert the electron beam 134 to the photon beam 135. For example, electrons from the electron beam 134 may occasionally pass close to a nucleus in the converter assembly plates 170p which causes the electrons to scatter through the converter assembly plates 170p with a large angle of incidence emitting a photon through bremsstrahlung radiation. The accumulation of these generated photons is the photon beam 135. One or more of the converter assembly plates 170p are made using a high Z material as previously mentioned.

Referring now to FIG. 4B, shown therein is a cross-sectional view of the XY slit system 160 across plane 4B-4B of FIG. 4A. The XY slit system 160 has an aperture 174 and may include a series of four sections, separated by slits 174a, 174b, 174c, and 174d. As is known by those skilled in the art, the sections can allow for monitoring the size and position of the electron beam 134. For example, temperature at each of the x-y slits 174a, 174b, 174c, and 174d can be measured using thermocouples. Beam loss may then be derived from the measured temperature as is known by those skilled in the art. If any unacceptable change in this measured temperature is detected, the electron beam provided by the accelerator that is used with the radioisotope production apparatus 100 can be adjusted or shut off.

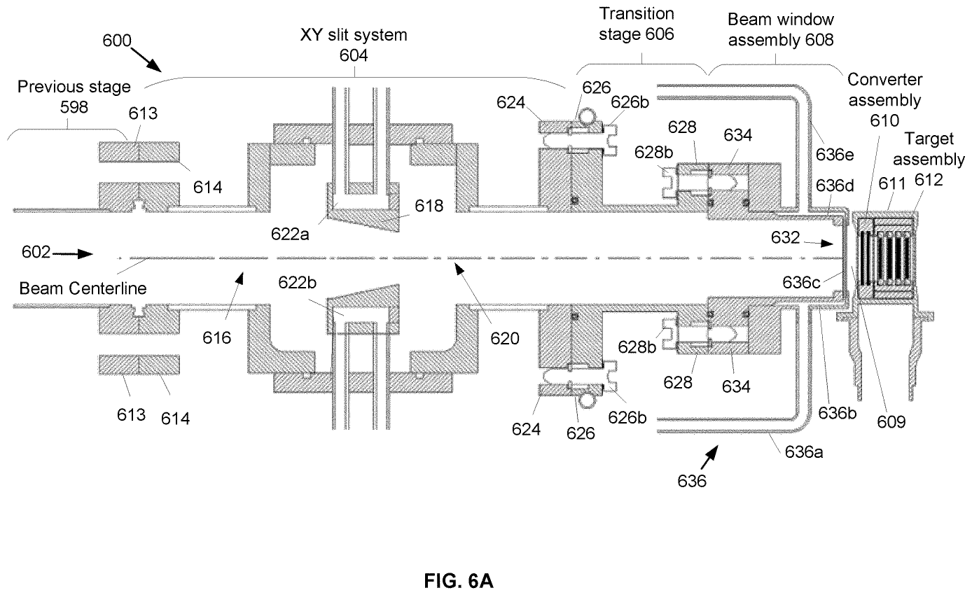

Referring now to FIG. 5, illustrated therein is a magnified view of the end of the beam line and the converter and target assemblies of the apparatus 100 shown in FIG. 2A. As seen in FIG. 5, the converter assembly 170 is generally located proximate and as close as possible to the target assembly 190. The converter assembly 170 includes a housing that 170h that is integrated into the end face of the housing 100h of the beam line such that there is a hermetic seal. The converter assembly window 176 is attached to the inward facing side of the converter assembly housing 170h. The converter assembly housing 170h is configured to hold the converter assembly window 176 and the converter plates 170p in position such that there is a space between the converter assembly window 176 and the first converter plate 170p, there are also spaces between the successive converter plates 170p (only one of which is labelled for simplicity), and there is a space between the last converter plate 170p and the end wall of the converter assembly housing 170h. Coolant may be passed through these spaces for cooling during use. The converter assembly housing 170h is also configured to hold the converter plates 170p in place such that they are approximately normal to the direction of electron beam propagation and vertically centered about the beam centre line. Apparatus 100. Directly upstream of the target plates 190p.

The target assembly 190 also has a housing 190h which is adapted to be in close proximity to the outward facing side of the converter assembly housing 170h. The outer shape of the end of the beam line portion of the apparatus 100 has a complimentary shape that mates with the shape of the side of the target assembly housing 190h. For example, the upper portion 100u of the end wall of the beamline of the apparatus 100 has a chamfered shoulder and the upper portion of the target assembly housing 190 has a shoulder 190s which has a complimentary shape so that the shoulder 190s of the target assembly housing 190h can be brought in close proximity with the upper portion 100u of the end wall of the apparatus housing 100h.

The target assembly housing 190h is adapted to hold one or more target plates 190p such that they are spaced apart from the front and back walls of the target assembly housing 190h and intersect the beam centre line. The target plates 190p (only one of which is numbered for simplicity) are also spaced apart from one another and mounted within the target assembly housing 190h so that the target plates are approximately normal to the electron beam during use and such that the broad face of the target plates 190p face the photon beam during use. Coolant may be passed between adjacent target plates 190p and target plates 190p that are adjacent to front and rear sidewalls of the target assembly housing 190h. The coolant flow may be provided via conduit 191 which may be a tube or pipe that is coupled to the bottom portion of the target assembly housing 190h. The target assembly 190 is configured to hold the target plates fixed in position during use. However, the target plates may be removed after use for harvesting of the radioisotopes from the irradiated target material.

In another aspect in accordance with the teachings herein, in at least one embodiment of the radioisotope production apparatus, the converter assembly and the target assembly may be located in a common housing where the converter assembly is not integrated in the beam line. In such embodiments, a beam window is included in the apparatus so that the converter assembly is physically separate from the beam line which improves ease of access to the converter assembly and/or the target assembly. This improves safety and is advantageous for situations in which it may be desirable to be able to inspect the converter plates or other components of the converter assembly 170 without having to disassemble any portion of the beam line.

Referring now to FIGS. 6A-6B, shown therein are side and magnified side views, respectively, of a portion of another example embodiment of an apparatus 600 for producing radioisotopes in accordance with the teachings herein where the converter assembly is not integrated in the beam line. The apparatus 600 includes an XY slit system 604, a transition stage 606, a beam window assembly 608, a converter assembly 610 and a target assembly 612 which are arranged downstream of one another as illustrated. Although not shown, the apparatus 600 is couplable to an accelerator assembly via one or more elements, such as an input aperture assembly, a scattering assembly and a scanning electromagnet, to receive an electron beam 602 therefrom that travels along the beam centerline as shown. For example, the input aperture assembly may be the high power aperture assembly 110, the scattering assembly may be the scattering assembly 130 and the scanning electromagnet may be the scanning electromagnet 150. In an alternative embodiment, the accelerator assembly includes magnets for providing beam shaping functionality as previously described so that the cross-sectional area of the electron beam 602 may be increased as previously described.

The XY slit system 604 is downstream of a previous stage 598, which may be a spacer such as spacer 102b, and has a somewhat similar structure as the XY slit system 160 shown in FIGS. 2, 4A and 4B. The XY system 604 is adapted for monitoring the size and position of the electron beam 602 for safety purposes. The XY system 604 includes connection elements 614 for connection to connection elements 613 of the previous stage 598. The connection elements 613 and 614 may be flanges such as, but not limited to, a DN 63 CF flange, for example. The XY slit system 604 includes an inlet 616 leading to a throat section 618 for allowing the electron beam 602 to pass while any stray electrons that hit the walls of the throat section 618 are stopped. The XY slit system 604 also includes an outlet 620 that is downstream of the throat section 618 through which the electron beam 602 passes as it travels to the transition stage 606 during use. Similar to the XY system 160, the XY system 604 has sections 622a and 622b that can allow for monitoring the size and position of the electron beam 602 by measuring temperature. If any unacceptable change in this measured temperature is detected, the electron beam 602 may be adjusted or shut off.

The XY slit system 604 also includes connection elements 624, such as flanges, for releasable connection to connection elements 626 of the transition stage 606 by using threaded bolts 626b, for example. The transition stage 606 may serve the same function as the second spacer 102b of the apparatus 100 shown in FIG. 2.

The transition stage 606 also includes connection elements 628, such as flanges, for releasable connection to connection elements 634 of the beam window assembly 608 by using threaded bolts 628b, for example. The beam window assembly 608 includes a beam window 632 including two sheets 632a and 632b that are spaced apart and oriented normal to the electron beam 602. In such cases, the beam window 632 may be referred to as a double window. The beam window 632 provides a hermetic seal for the components of the apparatus 600 upstream of the beam window 632 so that the interior of the apparatus 600 may be maintained at vacuum or near vacuum as explained previously. The beam window 632 also isolates the accelerator assembly from the converter and target assemblies 610 and 612 and may also allow the converter and target assemblies 610 and 612 to be in closer contact with one another.

The beam window assembly 608 may also include a cooling system 636, which may be integrated with another cooling system, such as that used for the converter and target assemblies 610 and 612 or may be a separate cooling system. For example, if there are multiple cooling systems then they may be integrated into one cooling system that is coupled to a common supply and return. Alternatively, if the cooling systems are separate and isolated from one another then this reduces the possibilities of alpha contamination to one cooling system. During use the coolant may be provided continuously or intermittently. The coolant can be operatively supplied via a pump.

During use, coolant flows through the cooling system 636 of the beam window assembly 608 to conduct heat away from the beam window assembly 608 and prevent overheating. The cooling system 636 of the beam window assembly 608 may include tube 636a, channel 636b, channel 636c, channel 636d and tube 636e that are fluidically coupled where the channel 636c extends along the length of the beam window 632 such that coolant is flowed between the sheets 632a and 632b of the beam window 632. Any suitable coolant may be used as is known by those skilled in the art such as water. For example, in at least one embodiment, the coolant may be Helium so that any loss of the sealing of the beam window 632 does not flood the accelerator assembly. In at least one embodiment, the beam window assembly may be configured to receive a coolant during use to be cooled to transmit the electron beam having a current up to about 1 mA.

In at least one embodiment, the sheets 632a and 632b may be made of foil material that is attached to portions of the housing above and below the electron beam window 632. For example, titanium foil may be used for both of the sheets 632a and 632b. Alternatively, in at least one embodiment, the sheets 632a and 632b may be made using Havar. The separation of the sheets 632a and 632b is preferably small such as on the order of millimeters or hundreds of microns and may be maintained at a low pressure such as about 2 atmospheres or less. Accordingly, the upper and lower portions of the sheets 632a and 632b which contact the housing are sealed which may be done using a seal material and/or a gasket. For example, silver-plated helicoflex gaskets that seal at a low force for an all-metal seal may be used.

In at least one embodiment, the beam window 632 may be implemented to be able to transmit an electron beam with a current of at least 1.25 mA and a FWHM greater than about 0.5 cm. In at least one embodiment, the electron beam may have a diameter from about 0.5 cm to up to about 2 cm (e.g., about 0.5, about 0.6, about 0.7, about 0.8, about 0.9, about 1.0, about 1.2, about 1.4, about 1.6, about 1.8, or about 2 cm, inclusive) with a diameter of about 1 cm being preferable in certain cases.

In at least one embodiment, where the electron beam power is relatively low, such as on the order of about 5 kW, for example, the beam window 632 may include just one plate and air-cooling may be used. However, such embodiments may not be able to be used in situations where the radioisotope production rate is to be maximized since in such cases more aggressive cooling is needed.

In at least one embodiment, as shown by the example embodiment of FIGS. 6A-6B, the converter and target assemblies 610 and 612 may be housed in a combined assembly as opposed to being separate assemblies.

The combined assembly has a housing 611 that is downstream and physically separate from the beam window 632 houses the converter assembly 610 and the target assembly 612 adjacent and as close as possible to one another. The housing 611 may be made using aluminum, titanium, steel or another suitable material. The housing 611 is spaced apart from the beam window 632 such that there is a gap 609 therebetween. The housing 611 has a side wall 611s that is directly downstream of the beam window 632 and has a thinner profile compared to other portions of the housing 611 to allow the electron beam to more easily travel therethrough (e.g., with less attenuation) to the converter assembly 610. In addition, a lower portion 611L or base of the housing 611 may be extended, such as by a few mm for example, to provide a ledge or shoulder that is disposed below the portion of the housing where the beam window 632 is located to enable closer spacing between the converter assembly 610 and the beam window 632 so that the gap 609 is smaller. In at least one embodiment, the gap 609 may be selected such that the distance between the beam window 632 and the first converter sheet 610p may be on the order of millimeters. For example, the gap may be in range of about 0.5 mm to about 5 mm (e.g., about 0.5, about 1, about 1.5, about 2, about 2.5, about 3, about 3.5, about 4, about 4.5 or about 5 mm, inclusive), and in some embodiments, may be about 1 mm. In some embodiments, the size of the gap 709 may be increased for greater safety while not greatly impacting yield of the radioisotope production. By reducing the size of the gap or this “clearance”, the interaction between the distribution of photons in the photon beam on the target material of the target assembly 612 can be increased to increase the overall production of radioisotopes.

The converter assembly 610 is located within a first portion of the housing 611. The converter assembly 610 includes a housing 610h with milled inner surfaces forming channels for receiving converter plates 610p (only one of which is labeled for ease of illustration) that have high Z material as explained earlier. The housing 610h may be made from similar materials as the housing 611. The converter plates 610p are spaced apart from one another as well as spaced apart from the walls of the housing 610h that are normal to the electron beam 601 during use. A coolant may be flowed between the converter plates 610p and the converter housing 610h to remove heat generated during use. For example, the flow may be into or out of the plane of FIG. 6B and limited within the converter assembly housing 610h. In alternative embodiments, there may be one or more than two converter plates 610b. The housing 610h of the converter assembly 610 is slidably received within the housing 611 to allow the converter assembly 610 to be removed for servicing and/or replacement of the converter plates 710p. In at least one embodiment, the converter assembly 610 may be configured to receive an electron beam having a power of up to about 50 kW due to the cooling that is provided.

The target assembly 612 is located within a housing 612h that is in a second portion of the housing 611 and is downstream of the first portion of the housing 611. The target assembly housing 612h including a first housing portion 612h1 and a second housing portion 612h2. The housings 612h1 and 612h2 may be made of a similar material as that used for the housing 611. The first housing portion 612h1 is adjacent the second portion of the housing 611 and the second housing portion 612h2 is located within the first housing portion 612h1. The second housing portion 612h2 has milled inner surfaces forming channels for receiving target plates 612p (only one of which is labeled for ease of illustration). The target plates 612p have target material for generation of the radioisotopes during use. The target plates 612p are spaced apart from one another as well as spaced apart from the walls of the housing 612h2 that are approximately normal to the photon beam during use. In alternative embodiments, there may be a different number of target plates compared to what is shown in FIGS. 6A-6B such as about 1 to about 20 target plates, for example. In at least one embodiment, the target plates 612p may be shaped as discs or rectangles. A coolant may be flowed between the target plates 612p and the inner target housing 612h2 to remove heat generated during use. For example, the flow may be into or out of the plane of FIG. 6B and limited within the target assembly housing 612h2. The housing 612h2 of the target assembly 612 is slidably received within the housing 612h1 to allow the target assembly 612 to be removed for servicing and/or replacement of the target plates 612p. The target plates 612p are also removable to harvest the produced radioisotopes.

The design of the housing 611 allows for the converter and target assemblies 610 and 612 to be integrated within the same housing thereby reducing the separation between the converter and target assemblies 610 and 612. For example, the housing 611 includes a wall 611w that physically separates the converter and target assemblies 610 and 612. Accordingly, the converter and target assemblies 610 and 612 are in separate sub-housings which can allow for different coolant flow to be provided to the converter and target assemblies 610 and 612. In at least one embodiment, this coolant flow provided to the converter assembly 610 may be in an opposite direction compared to the coolant flow provided to the target assembly 612.

In implementing the apparatus 600, certain components upstream of the target assembly 612 may be configured to handle an electron beam having a power of about 25 kW with high reliability. In at least one embodiment, these components may be configured to provide a safety factor and operate with an electron beam having a power of up to about 30 kW to about 40 kW, inclusive, when the beam diameter is about 15 mm. Alternatively, there may be at least one embodiment where the beam diameter may be about 10 mm to about 11 mm, inclusive. In such cases, the target plates 612p may be made of a suitable material based on the radioisotope to be generated and have a diameter of about 12 mm.

In at least one embodiment of the apparatus 600, the distance from the front of the first converter plate 610p of the converter assembly 610 to the first target plate 612p may be selected so that these elements are closely spaced providing a “tight geometry”. For example, the spacing may be on the order of millimeters. In some embodiments, there may generally be 2 to 6 converter plates which may have a thickness from about 0.5 mm to about 5 mm depending on the power level of the electron beam.

Referring now to FIG. 7A, illustrated therein is an example radioisotope production environment 700, in accordance with various embodiments. Radioisotope production environment 700 generally includes an enclosure 702 including a chamber 703 where a radioisotope generation apparatus 710 may be placed. The apparatus 710 may be any of the apparatus embodiments described herein. The enclosure 702 is defined by walls 704 that are generally formed of a material configured to attenuate radiation so as to prevent radiation from escaping into an external environment. The thickness of the walls 704 may depend on the power of input electron beam 708 which is transmitted within beam line 709, the type of radioisotopes to be produced and/or the type of materials to be used in the production process, the type of shielding that is used with the apparatus 710, the material used to form the walls 704, or other criteria. For example, concrete may be used to form walls 704.

Electron beam 708 enters enclosure 702 via the beam line 709 and may impinge upon beam shaping components of a beam shaping assembly of the radioisotope generation apparatus 710 depending on the particular apparatus embodiment that is used. In some embodiments, the electron beam 708 is approximately circular with a diameter from about 5 mm to about 15 mm, or may be another suitable diameter. The interaction of the electron beam 708 with the radioisotope generation apparatus 710 generally causes one or more radioisotopes to be produced as described herein. Radiation is generally created as a result of the electron beam 708 deaccelerating within the materials and structures of the radioisotope generation apparatus 710.

In general, scattered photons or other particles (e.g., neutrons) may be produced or otherwise enter enclosure 702 as a result of the interaction of the electron beam 708 with various components of the apparatus 710. These particles can be harmful to the external environment. Therefore, the walls 704 serve an important role in protecting the external environment. However, relying on the walls 704 alone to provide shielding may result in leaks or degradation to the walls 704 and also increase costs and complexity when decommissioning the apparatus 710 and the facility where the apparatus 710 is located. It is beneficial to have additional components that can be used to absorb particle energy, as well as reduce the shielding requirements for the walls 704. Doing so can decrease the costs associated with creating the enclosure 702, such as, for example, by minimizing material expenditure during the construction and/or maintenance of the walls 704.

In at least one embodiment, the radioisotope generation system 710 includes a beam dump, which is similar to beam dump 42, and is configured to absorb any excess electrons from the incident electron beam 708 that are not absorbed by the converter or target assemblies. The beam dump of the radioisotope generation apparatus 710 is also configured to absorb other excess particles such as any excess photons and/or excess neutrons which may, for example, be those produced as a result of the electron beam 708. The beam dump may reduce the amount of induced activity in the walls 704, as well as reduce the amount of material (e.g., concrete) needed for providing radiation safety.

Referring now to FIGS. 7B-7C, shown therein is a side view and top view of the radioisotope generation apparatus 710, in accordance with various embodiments described herein. The beam dump/shielding assembly of the radioisotope generation apparatus 710 generally include a first shielding assembly 752a and a second shielding assembly 752b which have components that are generally enclosed by the dashed ellipses shown in FIGS. 7B-7C. The first and second shielding assemblies 752a and 752b are releasably attachable to one another. For example, releasable fasteners such as screws or bolts, or releasable locking mechanisms such as latches, may be used to releasably attach the first and second shielding assemblies 752a and 752b. In at least one embodiment, portions of the first and second shielding assemblies 752a and 752b that are adjacent to one another may be interlaced or otherwise overlap. In at least one embodiment, a contact sensor may be used to ensure that the first and second shielding assemblies 752a and 752b are securely attached to one another before the electron beam is generated.

The first shielding assembly 752a may be referred to herein interchangeably as a front shielding assembly. The second shielding assembly 752b may be referred to herein interchangeably as a rear shielding assembly. The first shielding assembly 752a may include a first inner shielding assembly 754a and a first outer shielding assembly 756a. The second shielding assembly 752b may include a second inner shielding 754b and a second outer shielding 756b. The first inner shielding assembly 754a and the second inner shielding assembly 754b may be formed of a first material such as, but not limited to, steel, for example. The first outer shielding assembly 756a and the second outer shielding assembly 756b may be formed of a second material such as, but not limited to, polyethylene (PE), for example. In at least one embodiment, more than two shielding layers may be used, which may include alternating materials between layers. For example, a layer of steel may be followed by a layer of polyethylene, which may then be followed by a second layer of steel and a second layer of polyethylene, and so on depending on the number of layers that are used.

The first shielding assembly 752a generally includes an opening whereby the electron beam 709 enters the radioisotope generation apparatus 710. A channel may be formed by this opening, which may transverse the first outer shielding assembly 756a and the first inner shielding assembly 754a. Disposed along this channel, for example, within the first inner shielding assembly 754a, may optionally be a lead shielding 758. The lead shielding 758 may be annular in shape, however other configurations may be used. The electron beam 758 passes through an opening in the lead shielding 758. The lead shielding 758 may reduce the backscattered radiation produced in the converter and target assemblies of the apparatus 710, thereby limiting the impact on any system components located outside of the first shielding assembly 752a. Any excess particles from the electron beam 708, as well as radiation or other particles produced based on the impingement of the electron beam 708 on the target assembly 760, may be absorbed by the aluminum block 762 and other portions of the beam dump that surround the target assembly 760.

Even after the electron beam 708 has impinged the target assembly 760, some excess electrons may remain that have not been converted into photons by the converter material. These excess electrons may be in addition to other particles such as, for example, excess photons that remain due to not being absorbed by the target assembly 760. These excess electrons and other excess particles may be strongly forward directed (e.g., they may be directed towards the second shielding assembly 752b). The aluminum block 762 and the surrounding portions of the beam dump may be configured, based on their shape, thickness, and/or material as well as their location downstream of the converter assembly 758 and the target assembly 760 and/or surrounding the converter assembly 758 and the target assembly 760, to absorb some or all of these excess electrons and/or other excess particles.

The beam dump may be formed of a material with low induced radioactivity and good thermal conductivity as described herein. Examples of materials that may be used to construct the beam dump include, but are not limited to, aluminum, copper and steel. For example, aluminum may be used due to its low radioactive nature after irradiation compared to other materials like steel. In particular, aluminum may be better suited to absorb excess electrons and photons thereby reducing the overall radiation that is produced. However, steel may be more effective at absorbing excess photons. Accordingly, the aluminum block 762 is placed at the location of the shielding assembly where the radiation is most intense since Aluminum is less radioactive and produces fewer neutrons. However, the density of the shielding materials must also be considered so that the overall size of the shielding assembly is practical and fits within the enclosure 702 and doesn't require overly thick walls 704. For example, steel, which is denser than aluminum, may be used to form the components of the first inner shielding assembly 754a and the second inner shielding 754b that surround the aluminum block 762; however alternative materials may be used. For example, in at least one embodiment, lead may be used instead of steel. This may reduce induced radioactivity in the first inner shielding assembly 754a and the second inner shielding assembly 754b. Another material may also be used in addition to aluminum and steel or lead such as polyethylene which is better able to absorb stray neutrons.

In at least one embodiment, the beam dump may be configured to minimize long-term activation of the concrete walls, 704. It is also configured to reduce the radiation field in the chamber 703. For example, in at least one embodiment, the beam dump may be configured to attenuate the photon dose rate by more than about five orders of magnitude and the neutron dose rate by a factor of more than about four orders of magnitude. Because the photons are forward-directed, the shielding normal to the beam direction does not need to be as thick. The left-over photons are strongly forward-directed. Hence, more shielding may be used in the forward direction. However, neutrons are emitted almost isotropically and therefore the location of the polyethylene sheets are located uniformly over the surface of the beam dump. In these various embodiments, these characteristics may be achieved through the use of an appropriate amount of different materials, such as aluminum, steel and polyethylene, which may be determined by running simulations which uses power values for the electron beam that will be used in practice and uses different values for the geometries of various shielding materials that are made from these materials to obtain the combination of geometries and materials that result in the aforementioned characteristic, while resulting in an overall size for the shielding assembly that is practical, e.g., can fit within the enclosure 702.

As shown, the beam dump is generally formed of two sections, which are releasably coupled to one another such that they can be slid apart when access to one or more components of the apparatus 710. For example, the apparatus 710 may include first and second sets of wheels 760w1 and 760w2 that are coupled to the first and second shielding assemblies 752a and 752b, respectively. Accordingly, once the two shielding assemblies 752a and 752b are de-coupled from one another, they can be wheeled away from one another. This separation of the two shielding assemblies 752 and 754 may allow for easy access to the target chamber located within the target assembly housing of the target assembly 760 for performing servicing and/or modifications to any components of the target assembly 760.

In at least one embodiment, the beam dump may be formed at least in part by embedding an aluminum block 762 into steel. Similar to the previous examples described herein, the beam dump may be configured to intercept any leftover (e.g., scattered) photon beam (e.g., bremsstrahlung radiation) that was not absorbed by the target material. By intercepting the left-over photon beam, the aluminum block 762 of the beam dump may be able to reduce the induced radioactivity in the first inner shield assembly 754a and/or the second inner shield assembly 754b.

In at least one embodiment, the first inner shielding assembly 604a and the second inner shielding 754b assembly may be formed of steel. The steel of the first inner shielding assembly 754a and the second inner shielding assembly 754b may be used to attenuate at least some of the excess photons (as well as at least some of the excess neutrons) due to steel's properties.

In at least one embodiment, the first outer shielding 756a and the second outer shielding 756b are formed of polyethylene, which may be used to moderate and attenuate any excess neutrons due to polyethylene's properties. In particular, first outer shielding 756a and second outer shielding 756b may be configured to incorporate sheets of polyethylene that surround the beam dump and attenuate neutrons that escape from first inner shielding 754a and/or second inner shielding 754b (e.g., the steel).

Accordingly, the beam dump shown in FIGS. 7A-7C is advantageous for reducing the amount of radiation that is in the chamber 703 and thus not as much concrete is needed for the walls 704 of the enclosure 702. This also simplifies decommissioning of the apparatus after use which leads to lower costs.

In another aspect, in accordance with the teachings herein there is provided at least one method for producing one or more radioisotopes by using one of the embodiments of the apparatus or the system described herein. Referring now to FIG. 8, shown therein is an example embodiment of such a method (e.g., method 800). A portion of the method 800 may be performed by the controller 16 in terms of controlling the operation of the accelerator assembly (e.g., the electron beam source) when executing one or more software programs. The method 800 may be used to create various radioisotopes including, but not limited to, Copper-67, Actinium-225, Molybdenum-99, Scandium-47, or any other suitable radioisotope.

At step 802, the method 800 generally includes selecting materials that are used for the converter plates in the converter assembly and the target plates in the target assembly. For example, the material for the converter plates in the converter assembly is preferably a high Z material as described previously. For example, the material in the converter plates may be Palladium, Rhodium, Tantalum, Tungsten, any compound of Palladium, any compound of Rhodium, any compound of Tantalum, any compound of Tungsten, any alloy of Palladium, any alloy of Rhodium, any alloy of Tantalum, or any alloy of Tungsten. The material used in the target plates of the target assembly are generally chosen based on the radioisotopes to be created. For example, the target material may be Zinc-68, Radium-226, Molybdenum-100, Titanium-48, any compound of Zinc-68, any compound of Radium-226, any compound of Molybdenum-100, any compound of Titanium-48, an alloy of Zinc-68, an alloy of Radium-226, an alloy of Molybdenum-100 or an alloy of Titanium-48.

At step 804, the method 800 generally includes determining operating parameters of the system for generating the radioisotopes. These operating parameters may be stored in memory such as in memory unit 16b of the controller 16. Alternatively, the operating parameters may be received from another computing device or may be provided by an operator of the radioisotope generation apparatus via user interface 16d of the controller 16.

The operating parameters may include the energy of the electron beam, the beam current, the beam diameter (e.g., beam size) and safety settings such as maximum operating temperature and/or maximum operating current. For example, the energy of the electron beam may be selected within the range of about 10 MeV to about 50 MeV, inclusive. As another example, the beam current may be chosen to be about 1 mA, which corresponds to a beam power of 40 kW at a beam energy of about 40 MeV. As another example, the beam diameter may have a value that is selected between about 0.5 mm to about 20 mm, inclusive, or between about 0.5 mm to about 15 mm, inclusive. If the electron beam diameter is smaller (e.g., at the lower end of the range) then there may be an increase in local heating of one or more of the components of the radioisotope generation apparatus which may damage these components. Conversely, if the electron beam diameter is larger (e.g., at the upper end of the range), then more target material may be required.

At step 806, once values for the operating parameters are selected, the method 800 generally includes operating the system/apparatus according to the determined operating parameters. Safety monitoring may be performed during operation by measuring temperature and/or current at one or more components of the radiation generation apparatus as well as position of the electron beam at one or more locations within the apparatus. When the measured temperature and/or measured current values are outside of a predefined safe operating range or the electron beam is mis-aligned, then the operation of the accelerator may be adjusted, or the accelerator may be disabled, so that the electron beam can be adjusted or terminated.

At step 808, after the system has been operated for a sufficient period of time, the accelerator is disabled. A period of time may elapse so that the radioactivity of the target assembly and any elements of the enclosure surrounding the system is at a safe level. When this occurs, method 800 generally includes removing the processed target plates which may also be referred to as isotope target substrates after they have been subjected to the photon beam. This may include removing the target plates from the surrounding housing.

At step 810, the method 800 generally includes processing the target material to harvest the generated radioisotopes by performing procedures known to those skilled in the art. As previously described, depending on the target material that is used, the generated radioisotopes may be, but is not limited to, Copper-67, Actinium-225, Molybdenum-99, or Scandium-47, for example.

It is to be understood that the Applicant's teachings herein are not limited to the exact details of construction, operation, exact materials or embodiments shown and described, as obvious modifications and equivalents will be apparent to one skilled in the art. On the contrary, the applicant's teachings described and illustrated herein encompass various alternatives, modifications, and equivalents, without departing from the embodiments described herein, the general scope of which is defined in the appended claims.

What is claimed is:

1. An apparatus for producing one or more radioisotopes, wherein the apparatus comprises:
a converter assembly comprising a high Z material configured to receive an electron beam to generate a photon beam by bremsstrahlung radiation; and
a target assembly comprising a target material configured to receive the photon beam from the converter assembly to produce the one or more radioisotopes.

2. The apparatus of claim 1, further comprising a beam window located upstream of the converter and target assemblies, wherein the beam window is near an end portion of a beam line and is configured to isolate the beam line from downstream elements and to transmit the electron beam to the converter assembly during use.

3. The apparatus of claim 2, wherein the beam window is hermetically sealed to maintain a vacuum or near vacuum pressure in the apparatus upstream of the beam window.

4. The apparatus of claim 2 or claim 3, wherein the beam window comprises two sheets with a gap therebetween.

5. The apparatus of claim 4, wherein the gap is about 1 mm.

6. The apparatus of claim 4 or claim 5, wherein the beam window is coupled to a conduit for receiving a coolant between the two sheets during use.

7. The apparatus of claim 6, wherein the coolant comprises Helium or water.

8. The apparatus of any one of claims 2 to 7, wherein the beam window is made using titanium or Havar.

9. The apparatus of any one of claims 2 to 8, wherein the beam window is configured to receive a coolant during use to be cooled to transmit the electron beam having a current up to about 1 mA.

10. The apparatus of any one of claims 2 to 9, wherein the beam window is configured to transmit the electron beam with a diameter from about 0.5 cm to about 2 cm.

11. The apparatus of claim 1, wherein the converter assembly is integrated at an end of the beam line of the apparatus.

12. The apparatus of any one of claims 2 to 10, wherein the converter assembly and the target assembly are located in a common housing.

13. The apparatus of any one of claims 1 to 12, wherein the converter assembly comprises a housing including one or more converter plates having the high Z material.

14. The apparatus of any one of claims 1 to 13, wherein the high Z material comprises Palladium, Rhodium, Tantalum, Tungsten, any compound of Palladium, any compound of Rhodium, any compound of Tantalum, any compound of Tungsten, any alloy of Palladium, any alloy of Rhodium, any alloy of Tantalum, or any alloy of Tungsten.

15. The apparatus of claim 14, wherein Z is a number of protons in atoms of the high Z material where Z ranges from about 20 to about 90.

16. The apparatus of any one of claims 1 to 15, wherein the target assembly comprises at least one target plate including the target material.

17. The apparatus of any one of claims 1 to 16, wherein the target material comprises Zinc-68, Radium-226, Molybdenum-100, Titanium-48, any compound of Zinc-68, any compound of Radium-226, any compound of Molybdenum-100, any compound of Titanium-48, an alloy of Zinc-68, an alloy of Radium-226, an alloy of Molybdenum-100 or an alloy of Titanium-48.

18. The apparatus of any one of claims 1 to 17, wherein the target material is hermetically sealed by a surrounding material.

19. The apparatus of claim 18, wherein the surrounding material comprises copper, aluminum, any alloy of copper, or any alloy of aluminum.

20. The apparatus of any one of claims 1 to 18, further comprises a beam dump including a first shielding assembly and a second shielding assembly that are releasably couplable to one another and surround the converter and target assemblies, wherein the first and second shielding assemblies are configured to attenuate excess particles that do not contribute to generation of the one or more radioisotopes during usage of the apparatus.

21. The apparatus of claim 20, wherein the beam dump further comprises an aluminum block that is located downstream of the target assembly and is surrounded by one of the shielding assemblies, the aluminum block being configured to attenuate the excess particles that do not contribute to generation of the one or more radioisotopes during usage of the apparatus.

22. The apparatus of claim 20 or claim 21, wherein the beam dump further comprises a blanket of polyethylene located at an outer portion of the beam dump to attenuate neutrons that escape from the beam dump.

23. The apparatus of any one of claims 20 to 22, wherein the beam dump comprises materials having geometries selected to reduce photon dose rate by more than about five orders of magnitude and/or neutron dose rate by more than about four orders of magnitude.

24. The apparatus of any one of claims 20 to 23, wherein the excess particles include excess photons, excess electrons and/or excess neutrons.

25. The apparatus of any one of claims 20 to 24, wherein the first and/or second shielding assemblies are formed of aluminum, polyethylene (PE), lead, and/or steel.

26. The apparatus of any one of claims 20 to 25, wherein the first and/or second shielding assemblies comprise a plurality of shielding sheets at outer portions thereof.

27. The apparatus of any one of claims 20 to 26, wherein the first and second shielding assemblies comprise an outer shielding assembly and an inner shielding assembly.

28. The apparatus of claim 27, wherein the outer shielding assembly is formed of PE

29. The apparatus of claim 27 or claim 28, wherein the inner shielding assembly is formed of steel.

30. The apparatus of any one of claims 27 to 29, wherein the outer shielding assembly further comprises a first outer shielding assembly and a second outer shielding assembly.

31. The apparatus of any one of claims 27 to 30, wherein the inner shielding assembly further comprises a first inner shielding assembly and a second inner shielding assembly.

32. The apparatus of any one of claims 20 to 31, wherein the beam dump further comprises a lead shielding assembly that is located upstream of the converter and target assemblies and is configured to reduce backscattered radiation produced in the converter and target assemblies during use.

33. The apparatus of any one of claims 1 to 32, further comprising an aperture assembly that is upstream of the converter assembly, the aperture assembly being configured to stop any electrons of the electron beam that are not travelling through an aperture of the aperture assembly.

34. The apparatus of claim 33, further comprising a beam shaping assembly that is downstream of the aperture assembly and is configured to adjust an angular divergence or direction of the electron beam.

35. The apparatus of claim 34, wherein the beam shaping assembly includes a scanning electromagnet that is operated to apply a sweeping pattern to sweep the electron beam so that the swept electron beam covers a larger surface area of the converter assembly compared to an area of the electron beam.

36. The apparatus of claim 34 or claim 35, wherein the beam shaping assembly includes a scattering assembly that includes a scattering component that is configured to increase an angular divergence of the electron beam.

37. The apparatus of claim 36, wherein the scattering assembly comprises a shaft that is coupled to a drive belt and the scattering component is mounted to the shaft so that during operation the drive belt imparts rotational motion to the shaft and the scattering component to change a location of the scattering component that receives the electron beam to reduce overheating of the scattering component.

38. The apparatus of claim 36 or claim 37, wherein the scattering component is a foil made from Cobalt, Titanium, Tantalum, Molybdenum, any alloy of Cobalt, any alloy of Titanium, any alloy of Tantalum, or any alloy of Molybdenum.

39. A system for producing a radioisotope comprising:
an accelerator assembly for producing an electron beam, and
an apparatus for producing one or more radioisotopes, the apparatus being defined according to any one of claims 1 to 38.

40. A method for producing at least one radioisotope by using the system of claim 39, wherein the method comprises:
selecting converter and target materials used for the converter and target assemblies based on the at least one radioisotope to be created;
determining operating parameters of the system for generating the at least one radioisotope; and
operating the system according to the determined operating parameters to generate the at least one radioisotope at the target material.

41. The method of claim 40, wherein the method comprises selecting the material for the converter sheets from Palladium, Rhodium, Tantalum, Tungsten, any compound of Palladium, any compound of Rhodium, any compound of Tantalum, any compound of Tungsten, any alloy of Palladium, any alloy of Rhodium, any alloy of Tantalum, or any alloy of Tungsten.

42. The method of claim 40 or claim 41, wherein the method comprises selecting the material used in the target plates from Zinc-68, Radium-226, Molybdenum-100, Titanium-48, any compound of Zinc-68, any compound of Radium-226, any compound of Molybdenum-100, any compound of Titanium-48, an alloy of Zinc-68, an alloy of Radium-226, an alloy of Molybdenum-100 or an alloy of Titanium-48.

43. The method of any one of claims 40 to 42, wherein the method comprises selecting an energy of the electron beam within a range of about 10 MeV to about 50 MeV.

44. The method of any one of claims 40 to 43, wherein the method comprises selecting a beam diameter for the electron beam within a range of about 0.5 mm to about 15 mm.

45. The method of any one of claims 40 to 44, wherein the method comprises selecting a beam current of about 1 mA for the electron beam, which corresponds to a beam power of the electron beam being about 40 kW when the beam energy is about 40 MeV.

46. An apparatus for producing one or more radioisotopes, wherein the apparatus comprises:
a converter assembly comprising a high Z material configured to receive an electron beam to generate a photon beam by bremsstrahlung radiation;
a target assembly comprising a target material configured to receive the photon beam from the converter assembly to produce the one or more radioisotopes; and
a beam window located upstream of the converter and target assemblies, wherein the beam window is near an end portion of a beam line and is configured to isolate the beam line from downstream elements and to transmit the electron beam to the converter assembly during use.

47. The apparatus of claim 46, wherein the beam window is further defined according to any one of claims 2 to 10.

48. An apparatus for producing one or more radioisotopes, wherein the apparatus comprises:
a converter assembly comprising a high Z material configured to receive an electron beam to generate a photon beam by bremsstrahlung radiation;
a target assembly comprising a target material configured to receive the photon beam from the converter assembly to produce the one or more radioisotopes; and
a beam dump comprising a first shielding assembly and a second shielding assembly that are releasably couplable to one another and surround the converter and target assemblies, wherein the first and second shielding assemblies are configured to attenuate excess particles that do not contribute to generation of the one or more radioisotopes during usage of the apparatus and wherein the first and second shielding assemblies are detached for accessing the converter and/or target assemblies.

49. The apparatus of claim 48, wherein the beam dump is further defined according to any one of claims 20 to 32.

50. An apparatus for producing one or more radioisotopes, wherein the apparatus comprises:
a converter assembly comprising a high Z material configured to receive an electron beam to generate a photon beam by bremsstrahlung radiation;
a target assembly comprising a target material configured to receive the photon beam from the converter assembly to produce the one or more radioisotopes; and
a beam shaping assembly that is upstream of the converter assembly and is configured to adjust an angular divergence or direction of the electron beam.

51. The apparatus of claim 50, wherein the beam shaping assembly is further defined according to any one of claims 34 to 38.
